(19) United States
(12) Patent Application Publication
(10) Pub. No.: US 2022/0300296 A1
(43) Pub. Date: Sep. 22, 2022

(54) METHOD AND APPARATUS FOR CONSTRUCTING A NETWORK SERVICE

(71) Applicant: Rakuten Mobile, Inc., Tokyo (JP)

(72) Inventors: Abhishek SHARMA, Tokyo (JP); Surender Singh LAMBA, Tokyo (JP); Bharath RATHINAM, Tokyo (JP); Rahul ATRI, Singapore (SG)

(21) Appl. No.: 17/454,824

(22) Filed: Nov. 15, 2021

Related U.S. Application Data
(60) Provisional application No. 63/164,486, filed on Mar. 22, 2021.

(51) Int. Cl. G06F 9/448; G06F 9/30; G06F 9/4401

(52) U.S. Cl. CPC G06F 9/4498; G06F 9/3005; G06F 9/4403

(57) ABSTRACT

An apparatus includes a processor and a memory having computer readable instructions stored thereon that, when executed by the processor, cause the apparatus to cause a life cycle manager to cause a network element having one or more states defined in a state machine corresponding to the network element to transition one or more source states of the one or more states defined in the state machine to one or more destination states of the one or more states defined in the state machine based on an instruction to modify the network element. The apparatus is also caused to cause the life cycle manager to query a workflow manager to select one or more workflows to modify the network element based on the instruction to modify the network element and the transition of the one or more source states to the one or more destination states. The apparatus is further caused to cause the network element to be modified based on the selected one or more workflows.

### PRIORITY CLAIM AND CROSS-REFERENCE

This application claims priority to Provisional Application No. 63/164,486, filed Mar. 22, 2021, which is hereby incorporated by reference in its entirety.

### BACKGROUND

Network service providers and device manufacturers (e.g., wireless, cellular, etc.) are continually challenged to deliver value and convenience to consumers by, for example, providing compelling network services that are capable of being flexibly constructed, scalable and diverse.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a communication system, in accordance with one or more embodiments.

FIG. 2 is a diagram of a purchase screen, in accordance with one or more embodiments.

FIG. 3 is a diagram of a service requirement input, in accordance with one or more embodiments.

FIG. 4 is a diagram of a purchase confirmation screen, in accordance with one or more embodiments.

FIG. 5 is a diagram a purchase confirmation screen, in accordance with one or more embodiments.

FIG. 6 is a diagram of a data structure of a bundle file, in accordance with one or more embodiments.

FIG. 7 is a diagram of an onboarding screen, in accordance with one or more embodiments.

FIG. 8 is a functional block diagram showing example components of and functions implemented by a marketplace system and a network operating system, in accordance with one or more embodiments.

FIG. 9 is a diagram of a data structure of a data group based on a received bundle file, in accordance with one or more embodiments.

FIG. 10 is a diagram of a data structure of physical inventory data, in accordance with one or more embodiments.

FIG. 11 is a schematic diagram of a data structure of logical inventory data, in accordance with one or more embodiments.

FIG. 12 is a diagram of resource pool management data, in accordance with one or more embodiments.

FIG. 13 is a diagram of a data structure of planned data, in accordance with one or more embodiments.

FIG. 14 is a schematic diagram of planned data, in accordance with one or more embodiments.

FIG. 15 is a diagram of a data structure of busy level data, in accordance with one or more embodiments.

FIG. 16 is a diagram of updated resource pool management data, in accordance with one or more embodiments.

FIG. 17 is a diagram of a cloud-native network function descriptor, in accordance with one or more embodiments.

FIG. 18 is a diagram of a day 0 parameter (cloud-native network function instance), in accordance with one or more embodiments.

FIG. 19A is a flowchart of an onboarding process, in accordance with one or more embodiments.

FIG. 19B is a flowchart of an onboarding process, in accordance with one or more embodiments.

FIG. 20 is a flowchart of processes executed by a purchaser terminal, a marketplace system and a network operating system, in accordance with one or more embodiments.

FIG. 21 is a flowchart of processes executed by a purchaser terminal, a marketplace system and a network operating system, in accordance with one or more embodiments.

FIG. 22A is a flowchart of processes involving an end-to-end orchestrator unit, in accordance with one or more embodiments.

FIG. 22B is a flowchart of processes involving an end-to-end orchestrator unit, in accordance with one or more embodiments.

FIG. 22C is a flowchart of processes involving an end-to-end orchestrator unit, in accordance with one or more embodiments.

FIG. 22D is a flowchart of processes involving an end-to-end orchestrator unit, in accordance with one or more embodiments.

FIG. 22E is a flowchart of processes involving an end-to-end orchestrator unit, in accordance with one or more embodiments.

FIG. 22F is a flowchart of processes involving an end-to-end orchestrator unit, in accordance with one or more embodiments.

FIG. 22G is a flowchart of processes involving an end-to-end orchestrator unit, in accordance with one or more embodiments.

FIG. 23 is a block diagram of an end-to-end orchestrator unit 2300, in accordance with one or more embodiments.

FIG. 24 is a flowchart of a method for generating one or more workflows or one or more states, in accordance with one or more embodiments.

FIG. 25 is a flowchart of a process for registering a network element, in accordance with one or more embodiments.

FIG. 26 is a diagram of a workflow, in accordance with one or more embodiments.

FIG. 27 is a diagram of a workflow, in accordance with one or more embodiments.

FIG. 28 is a diagram of a workflow, in accordance with one or more embodiments.

FIG. 29 is a diagram of a state machine, in accordance with one or more embodiments.

FIG. 30 is a diagram of a state machine, in accordance with one or more embodiments.

FIGS. 31A-31D are diagrams of a state machine creation and code viewing interface, in accordance with one or more embodiments.

FIG. 32 is a diagram of a workflow selection interface, in accordance with one or more embodiments.

FIG. 33 is a diagram of a network element-type selection interface, in accordance with one or more embodiments.

FIG. 34 is a diagram of a process or event interface, in accordance with one or more embodiments.

FIG. 35 is a flow chart of processes performed by an end-to-end orchestrator unit, in accordance with one or more embodiments.

FIG. 36 is a function block diagram of a computer or processor-based system upon which or by which some embodiments are implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Network services are often provided by static or inflexible systems that are difficult to configure, scale, and deploy over various target areas. Network service providers are challenged to provide network systems and/or network services that are capable of being flexibly constructed, scalable and diverse.

Network functions virtualization (NFV) implements one or more network functions of a network appliance by way of software on a virtual machine (VM) which is caused to run on a virtualization layer such as a hypervisor on a server. Sometimes, a virtualized network function (VNF) corresponds to an application that operates on a virtual machine (VM) provided on a server to implement a network function by software. Some conventional networking systems deploy functional units in accordance with a purchase of a network service, and involve deconstructing an order of a product purchased by a customer into VNF units and deploying the VNF units on a network functions virtualization infrastructure (NFVI). NFVI is an infrastructure configured to virtualize, using a virtualization layer such as a hypervisor, hardware resources of a physical machine (e.g., a server) such as computing, storage and network functions, as virtualized hardware resources such as virtualized computing, virtualized storage, and virtualized network to allow flexible handling of the resources.

Some conventional networking systems deploy a network function unit to an available computing device according to a deployment request so as to satisfy an isolation requirement that is a requirement regarding non-sharing of a network function or network service. Other conventional networking systems allow multiple business operators to uniquely use all or a part of multiple network slices managed by a higher-level business operator.

Conventional networking systems, however, are not easily managed or capable of flexibly constructing networking services that easily customizable, scalable and/or meet various diverse needs without significant reconfiguration and testing of one or more network elements.

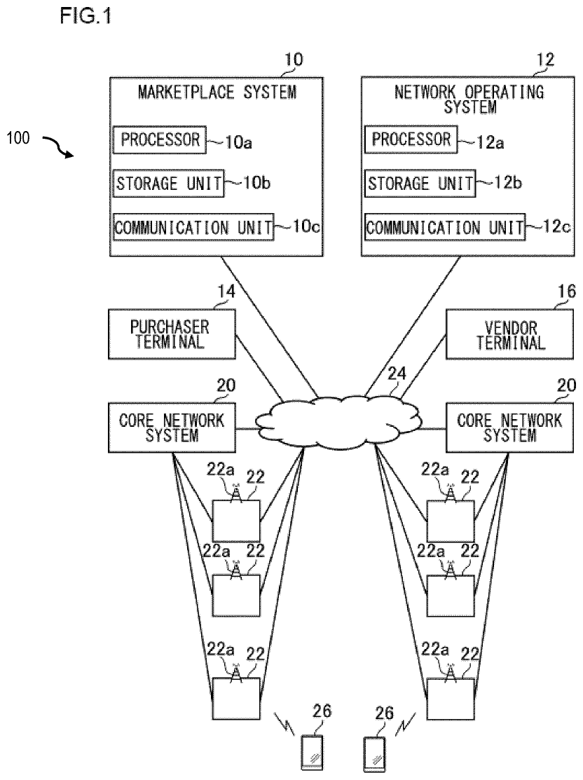

FIG. 1 is a diagram of a communication system 100, in accordance with one or more embodiments. Communication system 100 comprises a marketplace system (MPS) 10, a network operating system (NOS) 12, a purchaser terminal 14, a vendor terminal 16, a plurality of core network systems 20, and a plurality of base station devices 22 communicatively couple by way of a network 24.

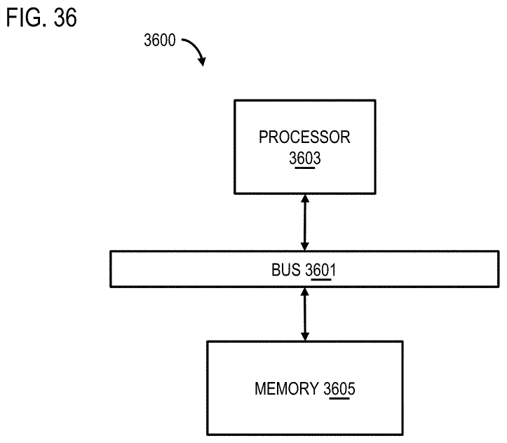

The core network system 20 is a system corresponding to an evolved packet core (EPC) in a fourth generation mobile communication system (hereinafter, referred to as 4G) or a 5G core network (5GC) including an access and mobility management function (AMF), a session management function (SMF), a user plane function (UPF), and the like in a fifth generation mobile communication system (hereinafter, referred to as 5G). The core network system 20 is implemented by a group of servers arranged in a plurality of data centers at various locations. A plurality of servers are arranged in each data center. One or more servers as described herein with respect to the various discussed embodiments is a computer or processor-based system having a processor and a memory such as that discussed with respect to computer or processor-based system 3600 (FIG. 36). Although two core network systems 20 are shown in FIG. 1, the number of core network systems 20 is not limited to two and may be one or three or more.

The base station device 22 is a computer system corresponding to an eNodeB (eNB) in 4G, an NR base station (gNB) in 5G, or a computer system having an antenna 22a. The base station device 22 includes one or a plurality of servers. In some embodiments, the base station device 22 is implemented by a group of servers arranged in a data center.

In some embodiments, a virtual distributed unit (vDU) and a virtual centralized unit (vCU), which are components of a radio access network (RAN) in 4G, are arranged in the base station device 22 and/or incorporated in a part of the core network system 20. In some embodiments, a distributed unit (DU) and a centralized unit (CU), which are components of the RAN in 5G, are arranged in the base station device 22 and/or incorporated in a part of the core network system 20.

The MPS 10 is configured on a cloud platform and includes a processor 10a, a storage unit 10b, and a communication unit 10c. The processor 10a is a program control device such as a microprocessor that operates according to a program installed in the MPS 10. The storage unit 10b is, for example, a storage element such as a ROM or RAM, a solid-state drive (SSD), a hard disk drive (HDD), or other suitable non-transitory storage medium. The storage unit 10b stores a program executed by the processor 10a. The communication unit 10c is, for example, a communication interface such as a network interface card (NIC) or a wireless LAN module. The communication unit 10c exchanges data with the NOS 12 and the purchaser terminal 14 via the network 24. In some embodiments, one or more of the processor 10a or the storage unit 10b corresponds to a processor 3603 (FIG. 36) or a memory 3605 included in a computer or processor-based system 3600 (FIG. 36) upon which or by which the MPS 10 is implemented.

The NOS 12 is configured on a cloud platform and includes a processor 12a, a storage unit 12b, and a communication unit 12c. The processor 12a is a program control device such as a microprocessor that operates according to a program installed in the NOS 12. The storage unit 12b is, for example, a storage element such as a ROM or RAM, a solid-state drive (SSD), a hard disk drive (HDD), or other suitable non-transitory storage medium. The storage unit 12b stores a program executed by the processor 12a. The communication unit 12c is, for example, a communication interface such as a NIC or a wireless LAN module. The communication unit 12c exchanges data with the MPS 10, the purchaser terminal 14, the vendor terminal 16, the core network system 20, and the base station device 22 via the network 24. In some embodiments, one or more of the processor 12a or the storage unit 12b corresponds to the processor 3603 or the memory 3605 included in the computer or processor-based system 3600 upon which or by which the NOS 12 is implemented.

In some embodiments, one or both of the MPS 10 or the NOS 12 is at least partially implemented by a processor 3603 included in separate computer or processor-based systems. In some embodiments, both of the MPS 10 and the NOS 12 are at least partially implemented by a processor 3603 included in a same computer or processor-based system. In some embodiments, the MPS 10 and the NOS 12 communicate directly with one another via a wired or wireless connection.

In response to a purchase request for a network service by a purchaser using purchaser terminal 14, for example, the network service for which the purchase request has been made is constructed in the core network system 20 and/or the base station device 22. Then, the constructed network service is provided to the purchaser.

For example, a network service such as a voice communication service, a data communication service, or the like is provided to a purchaser who is a mobile virtual network operator (MVNO). The voice communication service or the data communication service provided will be eventually provided to a customer/end user for the purchaser (MVNO in the above example), by way of user equipment (UE) 26. The customer/end user can the perform voice communication or data communication with other users via the core network system 20 or the base station device 22 using UE 26.

The network service provided is not limited to a voice communication service and a data communication service. In some embodiments, the network service provided is an IoT service. In some embodiments, a customer/end user who uses a robot arm, a connected car, or the like may be a purchaser of the network service. In some embodiments, the UE 26 is a type of mobile terminal, fixed terminal, or portable terminal including a desktop computer, laptop computer, notebook computer, netbook computer, tablet computer, wearable circuitry, mobile handset, server, gaming console, or combination thereof. In some embodiments, the UE 26 comprises a display by which a user interface is displayed.

A container type application execution environment is installed in the servers arranged in the core network system 20 and the base station device 22, and containers are capable of being deployed in these servers and operated. In some embodiments, the network service provided to the purchaser is implemented by a cloud-native network function (CNF), which is a container-based functional unit.

In some embodiments, the purchaser terminal 14 is a type of mobile terminal, fixed terminal, or portable terminal including a desktop computer, laptop computer, notebook computer, netbook computer, tablet computer, wearable circuitry, mobile handset, server, gaming console, or combination thereof. In some embodiments, the purchaser terminal 14 comprises a display by which a user interface is displayed.

In some embodiments, the vendor terminal 16 is a type of mobile terminal, fixed terminal, or portable terminal including a desktop computer, laptop computer, notebook computer, netbook computer, tablet computer, wearable circuitry, mobile handset, server, gaming console, or combination thereof. In some embodiments, the vendor terminal 16 comprises a display by which a user interface is displayed.

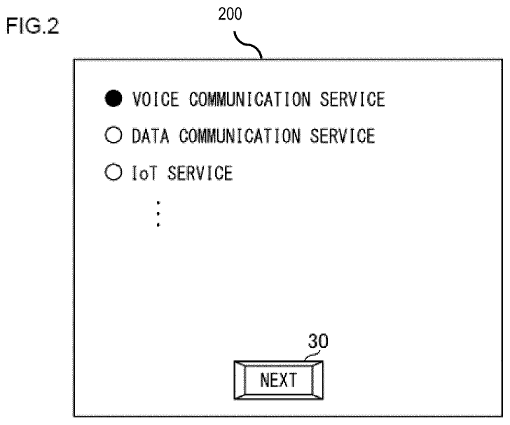

FIG. 2 is a diagram of a purchase screen 200 displayed on the purchaser terminal 14, in accordance with one or more embodiments.

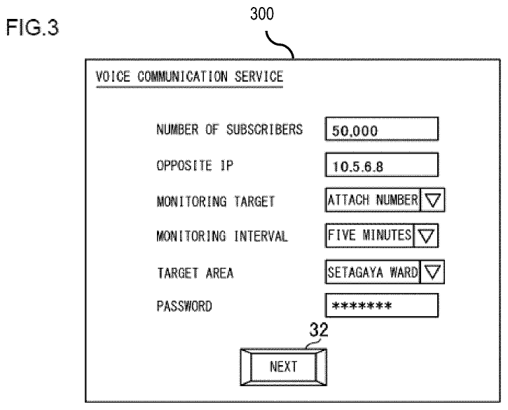

FIG. 3 is a diagram of a service requirement input screen 300 displayed on the purchaser terminal 14, in accordance with one or more embodiments.

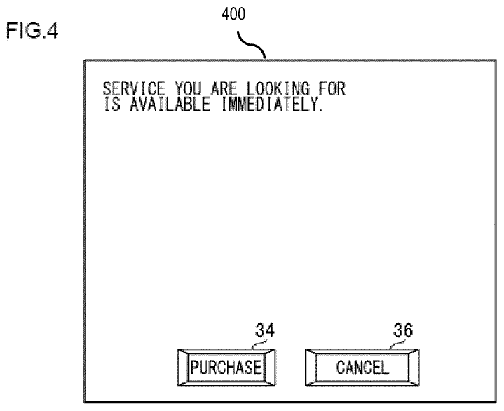

FIG. 4 is a diagram of a purchase confirmation screen 400 displayed on the purchaser terminal 14, in accordance with one or more embodiments.

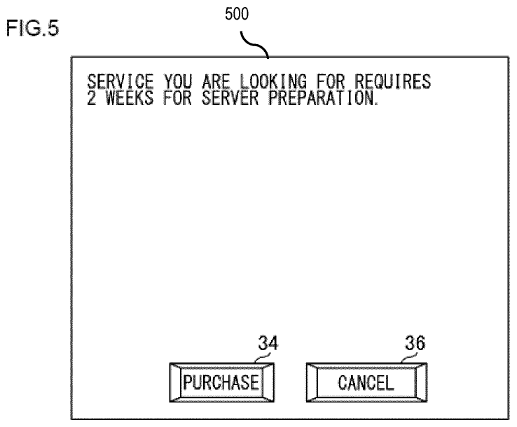

FIG. 5 is a diagram of a purchase confirmation screen 500 displayed on the purchaser terminal 14, in accordance with one or more embodiments.

The following refers to an example process for purchasing a network service that invokes some example instances of the purchase screen 200, the service requirement input screen 300, the purchase confirmation screen 400, and/or the purchase confirmation screen 500 discussed with respect to FIGS. 2-5.

On the purchase screen 200 shown in FIG. 2, a type of network service purchased by the purchaser is capable of being selected by a radio button. In some embodiments, purchase screen 200 is configured to facilitate selecting a type of network service by way of some other suitable user input. Here, when the purchaser specifies a voice communication service and clicks a next button 30, the purchaser terminal 14 displays a service requirement input screen 300 such as that shown in FIG. 3.

On the service requirement input screen 300, service requirements for the network service the purchaser is purchasing are capable of being entered. For example, the service requirement input screen 300 shown in FIG. 3 makes it possible for a number of subscribers, an opposite IP, a monitoring target, a monitoring interval, a target area, and a password to be set. The opposite IP refers to an IP address serving as an access point for the network system already possessed by the purchaser.

When the purchaser enters these service requirements and clicks the next button 32 in the service requirement input screen 300, service requirement data associated with the input onto the service requirement input screen 300 is transmitted to the MPS 10.

The service requirement data includes one or more of the subscriber number data indicating the number of subscribers, opposite IP data indicating the opposite IP, monitoring target data indicating the monitoring target, monitoring interval data indicating the monitoring interval of the monitoring target, target area data indicating the target area of the network service to be purchased, password data indicating the password, or other suitable pieces of data indicating other service requirements.

Based on the service requirement data, the MPS 10 cooperates with the NOS 12 to confirm whether it is possible to secure a server that satisfies the service requirements indicated by the service requirement data. For example, the MPS 10 determines whether (1) it is possible to secure a server that satisfies the service requirements, (2) it is possible to secure a server that satisfies the service requirements by setting up a free server, or (3) it is impossible to secure a server that satisfies the service requirements.

Based on a determination by the MPS 10 that (1) it is possible to secure a server that satisfies the service requirements or (2) it is possible to secure a server that satisfies the service requirements by setting up a free server, the purchaser terminal 14 displays a purchase confirmation screen 400 that indicates that immediate provision is possible, such as that shown in FIG. 4. Based on a determination by the MPS 10 that (3) it is impossible to secure a server that satisfies the service requirements, the purchaser terminal 14 displays a purchase confirmation screen 500 that indicates a predetermined turnaround time is required (e.g., a turnaround time of 2 weeks is required), such as that shown in FIG. 5.

When the purchaser clicks a purchase button 34, such as that shown in FIG. 4 or FIG. 5, a network service for which the purchase request has been made is constructed and provided to the purchaser.

On the other hand, when the purchaser clicks a cancel button 36, such as that shown in FIG. 4 or FIG. 5, the purchase is canceled.

A network service that meets various purchaser's needs is flexibly constructed.

Without being aware of the detailed implementation of the network service, the purchaser can receive the provision of a desired network service by only specifying some service requirements.

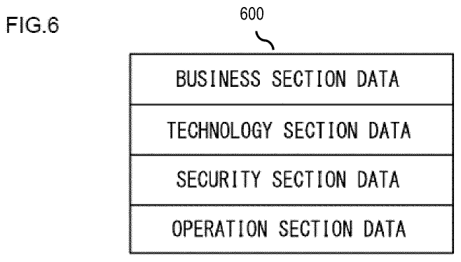

FIG. 6 is a diagram of a data structure of a bundle file 600, in accordance with one or more embodiments. The bundle file includes business section data, technology section data, security section data, and operation section data.

The vendor is provided with a continuous integration (CI)/continuous delivery (CD) pipeline including a development environment, a verification environment, and a test environment. In some embodiments, a verified bundle file corresponding to the network service to be provided to the purchaser, which is created by the vendor, is on-boarded by an onboarding process utilizing the CI/CD pipeline.

The bundle file is, for example, a file obtained by compressing a file group having a predetermined directory structure (e.g., a file in tar.gz format).

The business section data includes business requirements of the network service such as, for example, the name of the network service, license requirements, the definition of service level agreement (SLA), etc. In some embodiments, the business section data includes data indicating mandatory input items and optional input items for the service requirements of the network service.

The technology section data includes, for example, the configuration of a functional unit group that realizes the network service. In some embodiments, the technology section data includes, for example, the configurations of applications and CNFs that constitute the network service.

The security section data includes, for example, the security definition of the network service such as installation credentials, etc.

The operation section data includes, for example, the monitoring policy regarding the network service such as monitoring target metrics, monitoring intervals, etc.

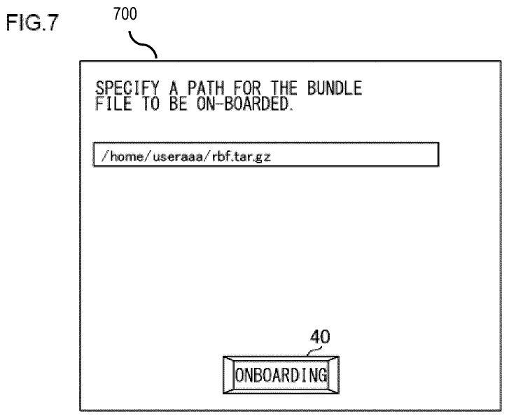

FIG. 7 is a diagram of an onboarding screen 700, in accordance with one or more embodiments. The onboarding screen 700 is displayed on the vendor terminal 16. When the vendor specifies a path where a bundle file is arranged and then clicks an onboarding button 40, the bundle file becomes on-boarded.

As described above, the vendor can easily perform onboarding of the network service without being aware of the actual location where a developed file group is on-boarded.

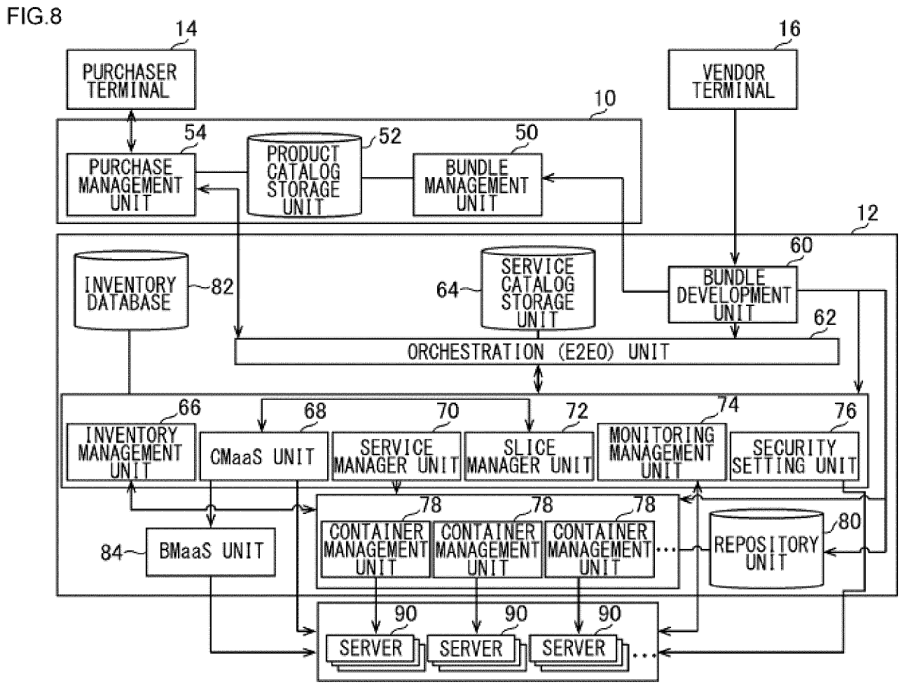

FIG. 8 is a functional block diagram showing example components of and functions implemented by the MPS 10 and the NOS 12, in accordance with one or more embodiments. In some embodiments, the MPS 10 and the NOS 12 implement some or all of the functions shown in FIG. 8. In some embodiments, MPS 10 and the NOS 12 implement one or more other suitable functions in addition to or in the alternative to those shown in FIG. 8

The MPS 10 functionally includes a bundle management unit 50, a product catalog storage unit 52, and a purchase management unit 54.

The bundle management unit 50 and the purchase management unit 54 are implemented, at least in part, by the processor 10a and/or processor 3603 and the communication unit 10c. The product catalog storage unit 52 is implemented, at least in part, by the storage unit 10b or other suitable memory.

In some embodiments, the above functions are implemented by executing a program that is installed in the MPS 10, which is a computer, and that includes instructions corresponding to the above functions executed by the processor 10a and/or processor 3603. In some embodiments, this program is supplied to the MPS 10 via a computer-readable information storage medium such as an optical disc, a magnetic disc, a magnetic tape, a magneto-optical disc, a flash memory, or the like, or via the Internet or the like.

Further, as shown in FIG. 8, the NOS 12 functionally includes, for example, a bundle development unit 60, an end-to-end orchestration (E2EO) unit 62, a service catalog storage unit 64, an inventory management unit 66, a Configuration Management as a Service (CMaaS) unit 68, a service manager unit 70, a slice manager unit 72, a monitoring management unit 74, a security setting unit 76, a plurality of container management units 78, a repository unit 80, an inventory database 82, and a Bare Metal as a Service (BMaaS) unit 84.

The bundle development unit 60 and the E2EO unit 62 are implemented, at least in part, by the processor 12a and/or processor 3603 and the communication unit 12c. The service catalog storage unit 64, the repository unit 80, and the inventory database 82 are implemented, at least in part, by the storage unit 12b or some other suitable memory. The inventory management unit 66, the CMaaS unit 68, the service manager unit 70, the slice manager unit 72, the monitoring management unit 74, the security setting unit 76, and the container management units 78 are implemented, at least in part, by the processor 12a and/or processor 3603 and the storage unit 12b or some other suitable memory. The BMaaS unit 84 is implemented, at least in part, by the processor 12a and/or processor 3603.

In some embodiments, the above functions are implemented by executing a program that is installed in the NOS 12, which is a computer, and that includes instructions corresponding to the above functions executed by the processor 12a. and/or processor 3603. In some embodiments, this program is supplied to the NOS 12 via a computer-readable information storage medium such as an optical disc, a magnetic disc, a magnetic tape, a magneto-optical disc, a flash memory, or some other suitable non-transitory computer readable medium, or via the Internet or the like.

FIG. 8 also shows a plurality of servers 90 included in the core network systems 20 and the base station devices 22 shown in FIG. 1, which distributed and arranged at various locations, and in communication with NOS 12. In some embodiments, each of the plurality of container management units 78 is associated with a server group that is a part of the plurality of servers 90.

In some embodiments, the container management units 78 include a container management tool and a package manager. In some embodiments, the container management tool is a kubernetes cluster, some other suitable cluster, or other suitable application or combination of node machines for running containerized applications. In some embodiments, the package manager is an application for managing the container management tool. In some embodiments, a package manager such as Helm or some other suitable application is installed as the package manager. In some embodiments, the container management unit 78 executes life cycle management of a container including the construction of the container such as the deployment and setting of the container for a server group (e.g., plurality of servers 90) associated with the container management unit 78. In some embodiments, E2EO unit 62 executes life cycle management of the container including the construction of the container such as the deployment and setting of the container for a server group (e.g., plurality of servers 90) associated with the container management unit 78. In some embodiments, one or more of the functions associated with container management unit 78 are performed by E2EO unit 62. In some embodiments, container management unit 78 is included in E2EO 62.

In some embodiments, the NOS 12 is free from including the container management unit 78. In some embodiments, the container management unit 78 is in, for example, a server 90 managed by the container management unit 78, or a server that is annexed to the server 90. In some embodiments, the container management unit 78 is included in the core network system 20, the base station device 22 or a server 90 associated with the core network system 20 or the base station device 22.

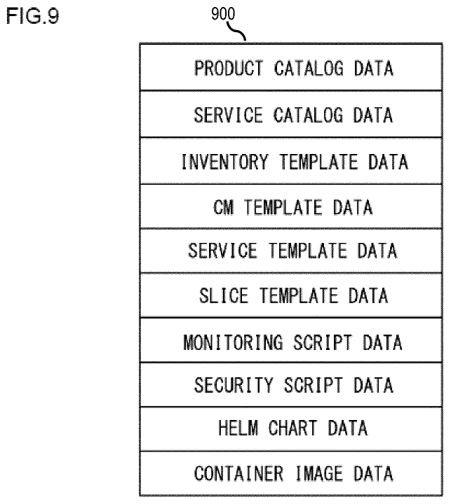

FIG. 9 is a diagram of a data structure of a data group 900 based on a received bundle file, in accordance with one or more embodiments. The bundle development unit 60 receives a bundle file from the vendor terminal 16. Then, the bundle development unit 60 generates a data group having the data structure as shown in FIG. 9 based on the received bundle file. The data group is obtained by reconstructing the contents of the received bundle file received by the bundle development unit 60.

The data group generated by the bundle development unit 60 includes product catalog data, service catalog data, inventory template data, configuration management (CM) template data, service template data, slice template data, monitoring script data, security script data, Helm chart data, and container image data.

The product catalog data is, for example, data corresponding to business section data included in the received bundle file. The product catalog data shows information regarding business requirements of the network service such as the name of the network service displayed on the purchase screen shown in FIG. 2, license requirements, the definition of the service level agreement (SLA), etc.

The product catalog data includes data indicating mandatory input items and optional input items for the service requirements of the network service. In some embodiments, the purchase screen 200 shown in FIG. 2 and the service requirement input screen 300 shown in FIG. 3 are generated based on the product catalog data.

The service catalog data is, for example, data corresponding to a part of the technology section data included in the received bundle file. The service catalog data contains one or more workflow scripts for building the network service.

In some embodiments, the service catalog data includes requirement configuration correspondence data indicating the correspondence between the value of the above service requirement data and the configuration of a functional unit group (e.g., a CNF group) constructed in response to a purchase request.

In some embodiments, the service catalog data includes one or more of requirement configuration correspondence data indicating the correspondence between the value of the service requirement data, the type of a functional unit group, and/or the number of functional units for each type. For example, the requirement configuration correspondence data may show that “20,000 subscribers and one packet data network gateway (P-GW)”, “20,000 subscribers and one IP multimedia system (IMS)”, and “20,000 subscribers and one home subscriber server (HSS)” correspond to one another. What is associated with the service requirement data is not limited to the type and number of 4G components, and the service requirement data and the type and number of 5G components may be associated with each other.

In some embodiments, the requirement configuration correspondence data indicates the correspondence between the value of the service requirement data and a location where each functional unit included in a functional unit group constructed in response to a purchase request is constructed. In some embodiments, the location associated with the value of the service requirement data in the requirement configuration correspondence data is different depending on the functional units included in the functional unit group that is constructed.

The inventory template data comprises, for example, data corresponding to a part of the technology section data and a part of the security section data included in the received bundle file. The inventory template data comprises, for example, template data indicating the logic used by the inventory management unit 66.

In some embodiments, the CM template data comprises data corresponding to a part of the technology section data and a part of the operation section data included in the received bundle file, and is, for example, template data indicating the logic used by the CMaaS unit 68.

The service template data comprises data corresponding to a part of the technology section data included in the received bundle file, and is, for example, template data indicating the logic used by the service manager unit 70.

The slice template data comprises data corresponding to a part of the technology section data included in the received bundle file, and is, for example, template data indicating the logic used by the slice manager unit 72.

The monitoring script data comprises data corresponding to a part of the operation section data included in the received bundle file, and is, for example, data indicating a monitoring script executed by the monitoring management unit 74.

The security script data comprises data corresponding to a part of the security section data included in the received bundle file, and is, for example, data indicating a script regarding security executed by the security setting unit 76.

The Helm chart data comprises data corresponding to a part of the operation section data included in the received bundle file, and is, for example, data indicating a script template (e.g., Helm chart) used by the container management unit 78.

The container image data comprises data corresponding to a part of the operation section data included in the bundle file, and is, for example, container image data of a container included in the functional unit group that realizes the network service. In some embodiments, the container image data includes one or a plurality of container images. A container image ID, which is an identifier of the container image, is optionally linked to each of the one or the plurality of container images.

In response to the reception of the bundle file, the bundle development unit 60 determines a bundle ID that corresponds to a data group generated based on the bundle file. A bundle ID is uniquely assigned to each generated data group.

The bundle development unit 60 links the product catalog data included in the data group corresponding to the bundle ID to the determined bundle ID, and transmits the product catalog data to the MPS 10.

The bundle development unit 60 outputs the service catalog data included in the data group to the E2EO unit 62 after linking the service catalog data to the determined bundle ID. The E2EO unit 62 stores the service catalog data in the service catalog storage unit 64.

The bundle development unit 60 links the inventory template data, the CM template data, the service template data, the slice template data, the monitoring script data, the security script data, the Helm chart data, and the container image data to the bundle ID corresponding to the data group, and stores the pieces of data in the inventory management unit 66, the CMaaS unit 68, the service manager unit 70, the slice manager unit 72, the monitoring management unit 74, the security setting unit 76, the container management unit 78, and the repository unit 80, respectively.

The product catalog data, the service catalog data, the inventory template data, the CM template data, the service template data, the slice template data, the monitoring script data, the security script data, the Helm chart data, and the container image data become linked to one another by the bundle ID.

The vendor can easily provide the network service by a simple operation such as specifying a path of the bundle file. In some embodiments, the path is specified by way of a user interface associated with the CI/CD pipeline that is accessible via vendor terminal 16.

In some embodiments, the bundle management unit 50 receives the product catalog data linked to the bundle ID transmitted from the bundle development unit 60. Then, the bundle management unit 50 stores the received product catalog data in the product catalog storage unit 52.

In some embodiments, the product catalog storage unit 52 stores the product catalog data linked to the bundle ID as described above.

The purchase management unit 54 receives a network service construction request such as a purchase request for a network service linked to the bundle ID and the service requirement data from the purchaser terminal 14. Hereinafter, a bundle ID linked to a purchase request is referred to as a purchase bundle ID, and service requirement data linked to a purchase request is referred to as purchase service requirement data.

The purchase management unit 54 transmits the purchase service requirement data linked to the purchase bundle ID to the E2EO unit 62 in response to the reception of the purchase request described above.

In cooperation with the E2EO unit 62 and the inventory management unit 66, the purchase management unit 54 identifies the turnaround time of the network service purchased by the purchaser. Then, the purchase management unit 54 notifies the purchaser of the identified turnaround time. In some embodiments, the purchase management unit 54 generates, for example, a purchase confirmation screen such as that shown in FIG. 4 or 5 indicating the identified turnaround time, and transmits the generated purchase confirmation screen to the purchaser terminal 14.

The inventory database 82 is, for example, a database in which inventory information for a plurality of servers 90 managed by the NOS 12 and arranged in the core network system 20 and the base station device 22 is stored.

In some embodiments, the inventory database 82 stores inventory data including physical inventory data and logical inventory data. The inventory data shows the status of resources managed by the NOS 12 (e.g., resource usage status).

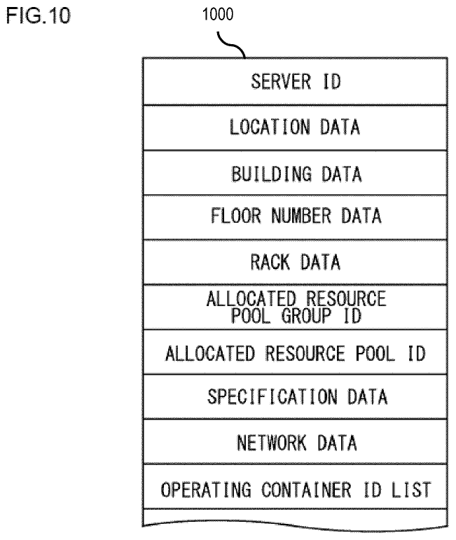

FIG. 10 is a diagram of a data structure of physical inventory data 1000, in accordance with one or more embodiments. The physical inventory data shown in FIG. 10 is associated with one server 90. The physical inventory data includes, for example, server ID, location data, building data, floor number data, rack data, allocated resource pool group ID, allocated resource pool ID, specification data, network data, operating container ID list, etc.

The server ID included in the physical inventory data is, for example, an identifier of the server 90 associated with the physical inventory data.

Location data included in the physical inventory data comprises data indicating the location of the server 90 (e.g., the address of the location) associated with the physical inventory data.

Building data included in the physical inventory data comprises data indicating a building (e.g., a building name) in which the server 90 associated with the physical inventory data is arranged.

Floor number data included in the physical inventory data is, for example, data indicating a floor number at which the server 90 associated with the physical inventory data is arranged.

Rack data included in the physical inventory data is, for example, an identifier of a rack in which the server 90 associated with the physical inventory data is arranged.

An allocated resource pool group ID included in the physical inventory data is, for example, an identifier of a resource pool group to which the server 90 associated with the physical inventory data is allocated.

An allocated resource pool ID included in the physical inventory data is, for example, an identifier of a resource pool to which the server 90 associated with the physical inventory data is allocated. A resource pool indicated by the allocated resource pool ID is any resource pool included in a resource pool group corresponding to the allocated resource pool group ID. The free server is assigned to any resource pool group. In some embodiments, it is undetermined to which resource pool included in the resource pool group the free server is assigned. For such a free server, null is set as the value of the allocated resource pool ID included in the corresponding physical inventory data.

The specification data included in the physical inventory data is data indicating the specifications of the server 90, such as the number of cores of the server 90 associated with the physical inventory data, the memory capacity, and the hard disk capacity.

The network data included in the physical inventory data is, for example, data indicating a NIC included in the server 90 associated with the physical inventory data, the number of ports included in the NIC, and the like.

The operating container ID list included in the physical inventory data is, for example, data indicating a list of identifiers (e.g., container IDs) of one or a plurality of container instances operating in the server 90 associated with the physical inventory data.

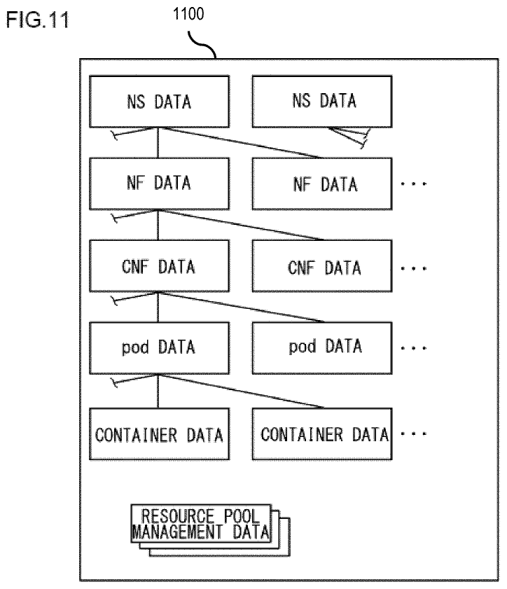

FIG. 11 is a schematic diagram of a data structure of logical inventory data 1100, in accordance with one or more embodiments. The logical inventory data includes network service (NS) data, network function (NF) data, CNF data, pod data, and container data.

The NS data is, for example, data indicating attributes such as an identifier of an instance of a network service corresponding to virtual RAN (vRAN) and the type of the network service. The NF data is, for example, data indicating attributes such as an identifier of an instance of a network function corresponding to eNodeB or the like and the type of the network function. The CNF data is, for example, data indicating attributes such as an identifier of an instance of CNF that corresponds to vCU, vDU, or the like and the type of the CNF. The pod data is data indicating attributes such as the identifier of an instance of a pod included in the CNF and the type of the pod. The pod refers to the minimum unit for managing a docker container by Kubernetes. The container data is data indicating attributes such as the container ID of an instance of a container included in the pod and the type of the container.

Data indicating attributes such as host name and IP address may be set in the above-mentioned data included in the logical inventory data. In some embodiments, the container data includes data indicating the IP address of a container corresponding to the container data. In some embodiments, the CNF data includes data indicating the IP address and host name of a CNF indicated by the CNF data.

The above data has a hierarchical structure, and the NS data is linked to one or a plurality of pieces of NF data respectively corresponding to one or a plurality of network functions included in a network service corresponding to the NS data. The NF data is linked to one or a plurality of pieces of CNF data respectively corresponding to one or a plurality of CNFs included in a network function corresponding to the NF data. The CNF data is linked to one or a plurality of pieces of pod data respectively corresponding to one or a plurality of pods included in a CNF corresponding to the CNF data. The pod data is linked to one or a plurality of pieces of container data respectively corresponding to one or a plurality of containers included in a pod corresponding to the pod data.

In some embodiments, an instance of the container and a server 90 on which the instance of the container is operating become linked to each other based on the container ID of the container data included in the logical inventory data and the container ID included in the operating container ID list included in the physical inventory data.

A network service purchased by the purchaser (e.g., a network service associated with product catalog data) does not need to correspond to a network service associated with the NS data. In some embodiments, the network service purchased by the purchaser is realized by a functional unit group corresponding to a network function associated with one or a plurality of pieces of NF data or may be realized by a functional unit group associated with one or a plurality of pieces of CNF data. In some embodiments, the network service purchased by the purchaser is realized by a functional unit group associated with one or a plurality of pods and/or is realized by a functional unit group associated with one or a plurality of containers.

In some embodiments, the logical inventory data includes a plurality of pieces of resource pool management data that are respectively associated with resource pool groups.

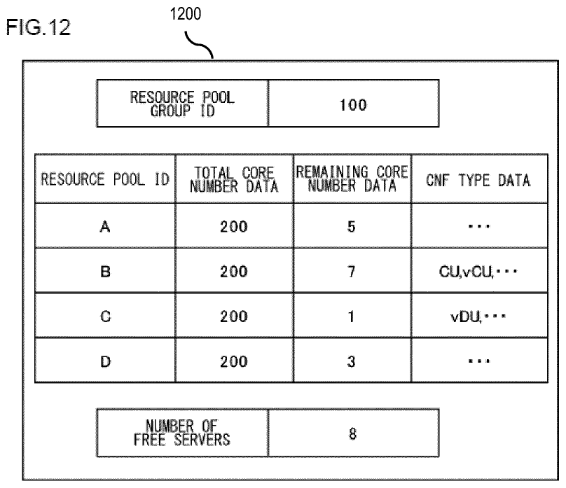

FIG. 12 is a diagram of resource pool management data 1200, in accordance with one or more embodiments. The resource pool management data indicates the status of a plurality of resource pools included in a resource pool group associated with the resource pool management data. In some embodiments, the resource pool management data comprises a resource pool group ID, a plurality of pieces of resource pool data, and free server number data.

The resource pool group ID included in the resource pool management data is an identifier of a resource pool group associated with the resource pool management data.

The free server number data included in the resource pool management data is data indicating the number of free servers allocated to the resource pool group associated with the resource pool management data.

The resource pool data is data indicating the status of resource pools included in a resource pool group associated with the resource pool management data.

In some embodiments, the resource pool data includes a resource pool ID, total core number data, remaining core number data, and CNF type data. A resource pool ID is an identifier of a resource pool.

The total core number data is data indicating the total number of cores of a server 90 allocated to the resource pool. The total core number data is an example of resource total amount data indicating the total amount of hardware resources included in the resource pool.

The remaining core number data is data indicating the number of remaining cores of the server 90 allocated to the resource pool. The remaining core number data is an example of resource remaining amount data indicating the remaining amount of the hardware resources included in the resource pool.

The CNF type data is data indicating one or more types of CNFs linked to the resource pool. The CNF type data is an example of functional unit type data indicating one or more types of functional units linked to the resource pool.

In some embodiments, a resource pool group that spans multiple locations is preset. In some embodiments, a resource pool group that is associated with only one location is preset. In either case, the resource pool group will be associated with one or a plurality of locations indicated by the physical inventory data.

The inventory management unit 66 appropriately grasps the resource status in cooperation with the container management unit 78 and updates the inventory data stored in the inventory database 82 based on the latest resource status.

The E2EO unit 62 and the inventory management unit 66 identify the configuration of a functional unit group that realizes a network service to be purchased. In some embodiments, E2EO unit 62 and the inventory management unit 66 identify the configuration of a functional unit group that realizes a network service to be purchased based on the service requirement data received from the purchase management unit 54.

For example, the E2EO unit 62 acquires, from the service catalog storage unit 64, service catalog data corresponding to a purchase bundle ID linked to the purchase service requirement data received from the purchase management unit 54. The E2EO unit 62 executes one or more corresponding workflow scripts indicated by the service catalog data.

In some embodiments, the E2EO unit 62 and the inventory management unit 66 generate planned data based on the purchase service requirement data received from the purchase management unit 54, the service catalog data linked to the purchase bundle ID, the inventory template data linked to the purchase bundle ID, and the inventory data. The planned data is, for example, data indicating the configuration of a functional unit group that realizes a network service to be purchased. This process is executed, for example, by the execution of one or more corresponding workflow scripts by the E2EO unit 62 as a trigger.

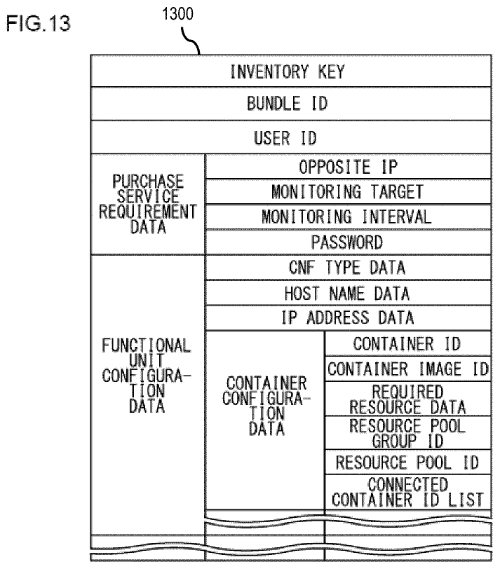

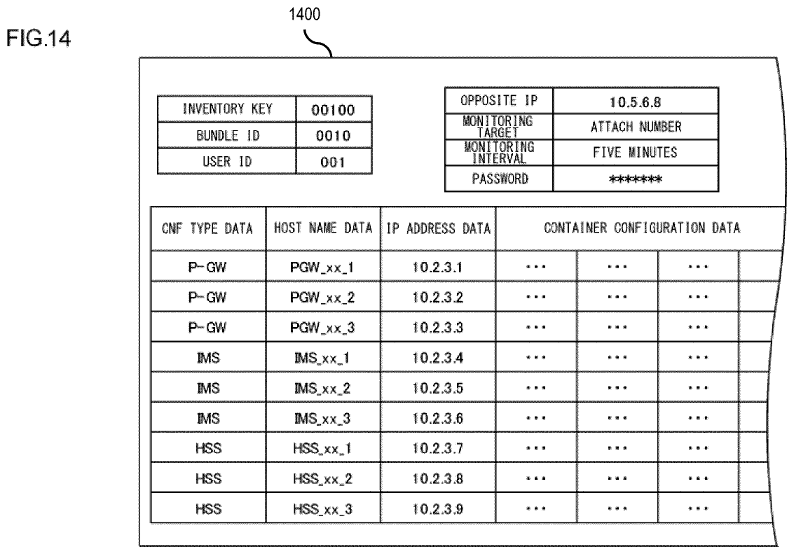

FIG. 13 is diagram of a data structure of planned data 1300, in accordance with one or more embodiments. FIG. 14 is a schematic diagram of the planned data, in accordance with one or more embodiments.

In some embodiments, the planned data includes an inventory key that is an identifier of the planned data. The inventory key is uniquely assigned to the planned data when the planned data is generated. In some embodiments, the planned data includes a purchase bundle ID (“0010” in the example of FIG. 14). In some embodiments, the planned data includes a user ID that is an identifier of the purchaser (user) who has made a purchase request.

In some embodiments, the planned data includes a value that is set based on the purchase service requirement data. In some embodiments, the planned data includes the value of opposite IP data, the value of monitoring target data, the value of monitoring interval data, and the value of password data included in the purchase service requirement data.

In some embodiments, the planned data includes functional unit configuration data for each of the functional units included in the functional unit group that realizes the network service to be purchased. The functional unit configuration data includes, for example, CNF type data indicating the type of the functional unit, host name data indicating the host name, IP address data indicating the IP address, and a plurality of pieces of container configuration data respectively associated with containers forming the functional unit.

Based on the purchase service requirement data, the E2EO unit 62 identifies the number of functional unit groups that are constructed. For example, the E2EO unit 62 identifies the respective types of functional unit groups that realize the network service to be purchased and the number of functional units for each type, based on the purchased service requirement data and the requirement configuration correspondence data included in the service catalog data. For example, based on a determination that the number of subscribers indicated by the service requirement data is 50,000, functional unit groups that are constructed are identified as three P-GWs, three IMSs, and three HSSs based on the above-described requirement configuration correspondence data.

In some embodiments, the E2EO unit 62 outputs the data indicating the respective types of functional unit groups and the number of functional units for each type to the inventory management unit 66 along with the service requirement data. The inventory management unit 66 then determines the host name and IP address assigned to each functional unit based on the data and the inventory data. In some embodiments, the host name and the IP address are determined so as not to be the same as host names or IP addresses that are already being used. The planned data including the host name data indicating the host name is thus determined and the IP address data indicating the determined IP address is generated.

In some embodiments, based on the purchase service requirement data, the E2EO unit 62 identifies the location where each of the functional units included in the constructed functional unit group is constructed. For example, in some embodiments, the E2EO unit 62 determines the location of each functional unit included in the constructed functional unit group based on the target area data included in the purchase service requirement data and the requirement configuration correspondence data included in the service catalog data. A different location may be determined for each functional unit. For each functional unit, a host name and an IP address available at the location determined for the functional unit may be determined as the host name and IP address of the functional unit. The planned data including the host name data indicating the host name then determined and the IP address data indicating the determined IP address is generated.

In some embodiments, based on the purchase service requirement data, the E2EO unit 62 identifies, for each of a plurality of locations, the type and number of functional units constructed at the location. In this case, in accordance with the location that is identified based on the purchase service requirement data, the E2EO unit 62 determines the number of functional units for each type that are constructed at the location. The E2EO unit 62 optionally determines the number of functional units for each type that are constructed for each location based on weight set for each location identified based on the purchase service requirement data.

As shown in FIG. 13, the container configuration data includes, for example, a container ID, a container image ID, required resource data, a resource pool group ID, a resource pool ID, and a connected container ID list.

The container ID is, for example, an identifier uniquely assigned to an instance of a container corresponding to the container configuration data.

As the container image ID included in the container configuration data, for example, a container image ID assigned to a container image of the container corresponding to the container configuration data is set.

The required resource data is, for example, data indicating a resource required to operate the container. In some embodiments, the inventory template data indicates, for each container, the resource required to operate the container. The inventory management unit 66 sets the value of the required resource data based on the inventory template data.

In some embodiments, for the resource pool group ID included in the container configuration data, the value of the resource pool group ID of a resource pool group to which the container corresponding to the container configuration data is assigned is set. The inventory management unit 66, in some embodiments, determines a resource pool group ID for which the container is constructed based on the location determined as described above and the inventory data.

In some embodiments, for the resource pool ID included in the container configuration data, the value of the resource pool ID of a resource pool to which the container corresponding to the container configuration data is assigned is set. The inventory management unit 66, in some embodiments, determines a resource pool ID based on the type of the container and the resource pool management data.

The connected container ID list is a list of container IDs of containers connected to the container. In some embodiments, the inventory template data indicates, for each container, the type of a container connected to the container. In some embodiments, the inventory management unit 66 determines the value of the connected container ID list based on the inventory template data and the inventory data.

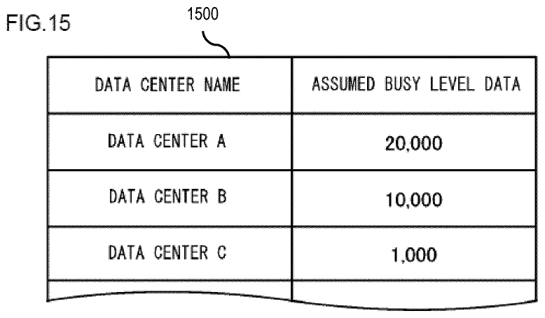

FIG. 15 is a diagram of busy level data 1500, in accordance with one or more embodiments. In some embodiments, the E2EO unit 62 may store assumed busy level data such as that shown in FIG. 15. The assumed busy level data indicates, for example, the population of an area covered by one or a plurality of cells under the control of a data center linked to the assumed busy level data. The value of the assumed busy level data is an example of the weight set for each location described above.

The assumed busy level data for the data center of the core network system 20 indicates, for example, the population of the area covered by the cells of one or a plurality of base station devices 22 communicating with the core network system 20.

In some embodiments, more functional units are deployed at a location with a higher population indicated by the assumed busy level data. For example, it is assumed that the total number n of vDUs to be deployed is identified based on the subscriber number data included in the purchase service requirement data. Then, it is assumed that a plurality of data centers, which are vDUs' deployment destinations, located within a target area indicated by the target area data are identified based on the target area data included in the purchase service requirement data. In this case, based on the value of the assumed busy level data for each identified data center, a number of vDUs obtained by proportionally dividing the total number n of identified vDUs may be deployed at each data center.

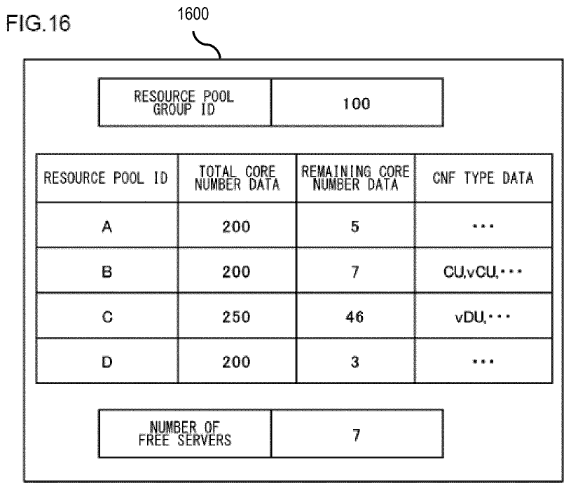

FIG. 16 is a diagram of updated resource pool management data 1600, in accordance with one or more embodiments.

When generating the planned data, the E2EO unit 62 identifies a resource pool in which a new functional unit group is deployed and a necessary resource in cooperation with the inventory management unit 66. The E2EO unit 62 identifies a resource pool linked to a functional unit identified in response to the receipt of a network service construction request such as the receipt of a purchase request. In some embodiments, the E2EO unit 62 identifies a resource pool group based on the target area of the network service to be purchased. For example, the resource pool group may be identified based on the target area indicated by the target area data included in the purchase service requirement data. The E2EO unit 62 then identifies a resource pool in which a new functional unit group is deployed from among resource pools included in the identified resource pool group.

The E2EO unit 62 determines whether or not a hardware resource (e.g., the server 90) in which the new functional unit group is deployed can be secured. For example, it is determined whether (1) the server 90 can be secured, (2) the server 90 can be secured by setting up an unused hardware resource (e.g., a free server in this case) that is not included in any resource pool, or (3) the server 90 cannot be secured.

If the E2EO unit 62 determines (2) the server 90 can be secured by setting up an unused hardware resource that is not included in any resource pool, the E2EO unit 62 determines whether or not a predetermined specific type of functional unit is deployed in an unused hardware resource (e.g., a free server).

When a specific type of functional unit is deployed, the E2EO unit 62 identifies a resource pool linked to the specific type of functional unit. For example, the resource pool is identified based on the resource pool management data.

In some embodiments, the resource pool ID of the resource pool group identified as described above and the resource pool ID of the identified resource pool are set in the container configuration data.

In some embodiments, based on the configuration of the functional unit group identified as described above and template data that can accept the configuration as a parameter, the CMaaS unit 68, the service manager unit 70, and the slice manager unit 72 identify a construction procedure of the functional unit group. In some embodiments, the construction procedure includes a procedure of container configuration management such as deploying a container and setting the deployed container and a container related to the container. This process is executed, for example, by the execution of one or more corresponding workflow scripts by the E2EO unit 62 as a trigger.

The CMaaS unit 68, the service manager unit 70, the slice manager unit 72, and the container management unit 78 construct a functional unit group by executing the identified construction procedure. This process is also executed, for example, by the execution of one or more corresponding workflow scripts by the E2EO unit 62 as a trigger.

Each of the functional units included in the functional unit group may be constructed at a location identified for the functional unit.

In some embodiments, a number of functional unit groups identified based on the purchase service requirement data are constructed.

For each of a plurality of locations, an identified number of functional units of a type identified for the location are optionally constructed.

The CMaaS unit 68 and the BMaaS unit 84 secure, for example, a hardware resource (e.g., the server 90) in which a new functional unit group is deployed.

The CMaaS unit 68 and the BMaaS unit 84 perform a system software setup according to a specific type of functional unit on an unused hardware resource. In some embodiments, the CMaaS unit 68 or the BMaaS unit 84 stores a script (e.g., an Ansible script) for performing a setup for the above-mentioned specific type of functional unit. The script describes, for example, a procedure of installing a host operating system (OS) that is a base of a container execution environment, a procedure of setting a kernel of the host OS, a procedure of setting a basic input output system (BIOS), which are of a specific type or a specific version. Then, by the execution of the script by the BMaaS unit 84, a system software setup according to the specific type of functional unit is performed on a free server. For example, the setup of the host OS and the BIOS of the container execution environment is performed on the free server.

The CMaaS unit 68 and the BMaaS unit 84 then update the resource pool management data so as to add the unused hardware resource on which the system software setup is performed to the identified resource pool. Such addition of the hardware resource to the resource pool is detected by the container management unit 78 that manages the hardware resource. The inventory management unit 66 updates inventory data that corresponds to the added hardware resource (e.g., server 90). This allows the resource pool to include the hardware resource on which the system software setup according to the specific type of functional unit is performed.

For example, vDU is assumed to be a specific type of functional unit. It is also assumed that the number of cores required for vDU is 5 and the number of free server cores is 50.

In this example, a resource pool linked to vDU is identified when a network service including vDU is purchased. In the example shown in FIG. 12, a resource pool with a resource pool ID is C is identified. A determination of whether or not the remaining hardware resources of this resource pool are sufficient is made. Based on a determination that the remaining hardware resources are insufficient, a system software setup according to vDU is performed on one free server. The server 90 on which the system software setup has been performed is then added to the resource pool C, and the resource pool management data is updated to that shown in FIG. 16.

In this manner, a system software setup according to one or more types of functional units linked to the resource pool is performed on the hardware resources included in the resource pool corresponding to the resource pool data.

In some embodiments, depending on the type of a functional unit, sufficient performance may not be able to be exhibited using a general-purpose server having a general configuration. Therefore, for such a specific type of functional unit, a dedicated setup is performed on hardware resources such as a server with regard to system software such as a host OS and BIOS. In this case, one possible option is to prepare in advance the required number of hardware resources on which such a dedicated system software setup has been performed before starting to provide the network service and the functional unit on the prepared hardware resources is deployed.

It is sometimes difficult to estimate the optimal amount of hardware resources on which the system software setup according to the specific type of functional unit should be performed in advance before starting to provide the network service. Also, if the system software setup according to the specific type of functional unit is performed on many hardware resources with an enough margin, such hardware resources are sometimes not suitable for the deployment of other functional units and thus result in wasting of resources.

In some embodiments, when deploying a specific type of functional unit on an unused hardware resource, a system software setup according to the specific type of functional unit is performed on an unused hardware resource. The unused hardware resource on which the system software setup has been performed is then added to a resource pool linked to the specific type of functional unit.

In this manner, it is possible to effectively utilize hardware resources on which various functional units that realize a network service are deployed.

In some embodiments, the functional units are identified based on the result of demand forecasting. For example, based on the result of the demand forecasting, functional units predicted to be in short supply in the near future are identified. A resource pool linked to the functional units identified are identified. An unused hardware resource on which a system software setup according to the functional units has been performed may then be added to the resource pool.

In some embodiments, based on a determination that the hardware resource for deploying a new functional unit group is secured, the service manager unit 70 instructs the container management unit 78 to deploy the new functional unit group based on the planned data and service template data linked to the purchase bundle ID stored in the service manager unit 70. The service template data can receive a part or all of the planned data as a parameter.

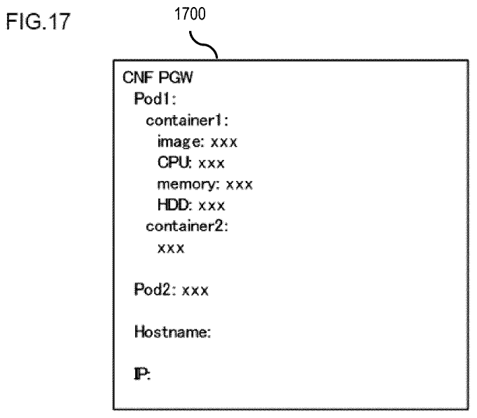

FIG. 17 is a diagram showing an example of a CNF descriptor (CNFD) 1700, in accordance with one or more embodiments. A CNFD is an example of the service template data.

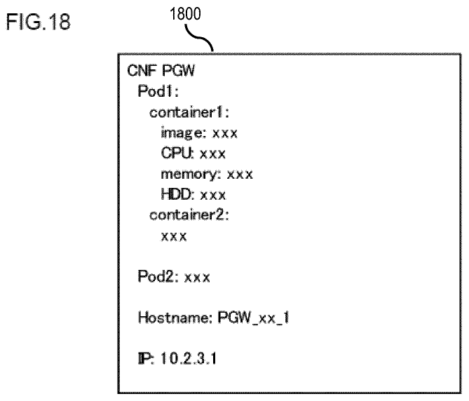

FIG. 18 is a diagram of an example a day 0 parameter (CNF instance) 1800, in accordance with one or more embodiments. The service manager unit 70 generates, for example, the day 0 parameter (CNF instance) based on the planned data and the CNFD. For example, the day 0 parameter is generated where a host name and the value of an IP address of the CNFD are set.

In some embodiments, the CNFD includes a template associated with each of a plurality of deployment flavors. The service manager unit 70 then generates the day 0 parameter based on a template corresponding to a deployment flavor according to the purchase service requirement data.

The service manager unit 70 optionally identifies the location of the output destination of the day 0 parameter. For example, one or a plurality of container management units 78 that serve as output destinations of the day 0 parameter may be identified. In some embodiments, a container management unit 78 associated with a server 90 arranged at the location of a resource pool indicated by the container configuration data of the planned data are identified. Then, a day 0 parameter that is output to each of identified locations is generated. For example, a day 0 parameter that is output to each of one or a plurality of container management units 78 that serve as the output destinations may be generated.

The service manager unit 70 then outputs each of the generated one or plurality of day 0 parameters to a container management unit 78 serving as the location of the output destination of the day 0 parameter. A purchase bundle ID is linked to the day 0 parameter.

The container management unit 78 deploys a new functional unit group based on the received day 0 parameter. The container management unit 78 identifies a container image to be deployed and a resource pool in which the container is deployed, for example, based on Helm chart data associated with the purchase bundle ID and on the received day 0 parameter. The container management unit 78 then acquires the container image from the repository unit 80 and deploys a container corresponding to the container image in the identified resource pool. For example, a manifest file is generated based on the Helm chart data associated with the purchase bundle ID and on the received day 0 parameter, and a container using the manifest file is deployed.

In some embodiments, the CMaaS unit 68 generates planned CM data including a day 1 parameter based on the planned data and CM template data stored in the CMaaS unit 68 and linked to the purchase bundle ID. The CM template data receives a part or all of the planned data as a parameter.

The day 1 parameter indicates, for example, a configuration management procedure such as the settings of a deployed functional unit group and at least one functional unit related to the functional unit group (e.g., a functional unit communicating with the deployed functional unit group). In some embodiments, a day 1 parameter according to the base station device 22 indicates, for example, radio field intensity, the direction and angle of the antenna 22a, a serial number, and the like. In some embodiments, a day 1 parameter according to a serving-gateway (S-GW) indicates, for example, information indicating an opposite node (information indicating the mobility management entity (MME) or the access point name (APN) of a communication partner), the host name or FQDN of a Remote Authentication Dial In User Service (RADIUS) server, or some other suitable information.

The CMaaS unit 68 then performs configuration management such as the setting of the functional unit based on the day 1 parameter included in the generated planned CM data. These processes are executed, for example, by the execution of one or more corresponding workflow scripts by the E2EO unit 62 as a trigger.

The slice manager unit 72 then performs, for example, instantiation of a network slice pertaining to a network service to be purchased, based on the above-mentioned planned data and slice template data linked to the purchase bundle ID stored in the slice manager unit 72. The slice template data can receive a part or all of the planned data as a parameter. This process is executed, for example, by the execution of one or more corresponding workflow scripts by the E2EO unit 62 as a trigger.

In some embodiments, the slice manager unit 72 outputs a configuration management instruction related to the instantiation of the network slice to the CMaaS unit 68. Then, the CMaaS unit 68 performs configuration management such as settings according to the configuration management instruction.

For example, the CMaaS unit 68 performs configuration management regarding new functional unit groups when the deployment of the new functional unit groups is completed and then perform configuration management related to the instantiation of the network slice.

Alternatively, the CMaaS unit 68 may update a once-generated day 1 parameter based on the configuration management instruction received from the slice manager unit 72. The CMaaS unit 68 then collectively performs the configuration management related to the new functional unit groups and the instantiation of the network slice.

In some embodiments, the monitoring management unit 74 identifies a monitoring policy indicated by the purchase service requirement data based on the above-mentioned planned data and monitoring script data linked to the purchase bundle ID stored in the monitoring management unit 74. The monitoring management unit 74 executes a monitoring setting according to the identified monitoring policy. Then, in accordance with the identified monitoring policy, the monitoring management unit 74 monitors a functional unit group that is constructed. For example, monitoring of a monitoring target indicated by the purchase service requirement data may be performed at a monitoring interval indicated by the purchase service requirement data. This process is executed, for example, by the execution of one or more corresponding workflow scripts by the E2EO unit 62 as a trigger.

In some embodiments, the monitoring management unit 74 may deploy, for example, a sidecar that outputs the value of the metric of the monitoring target linked to the container of the monitoring target as a log at the above-described monitoring interval. The sidecar then outputs the log to the monitoring management unit 74 in accordance with the above-mentioned monitoring setting. The monitoring management unit 74 may accumulate the log. Then, the monitoring management unit 74 transmits the log to the purchaser terminal 14 in response to a request from the purchaser terminal 14.

In some embodiments, the security setting unit 76 executes a security setting such as a password setting in accordance with the value of the purchase service requirement data based on the above-described planned data and the security script data stored in the security setting unit 76 and linked to the purchase bundle ID.

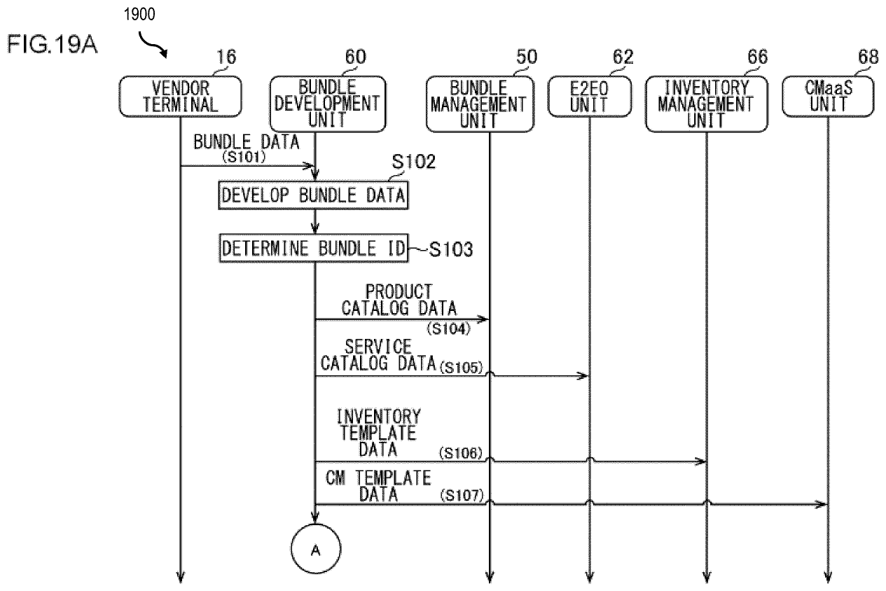

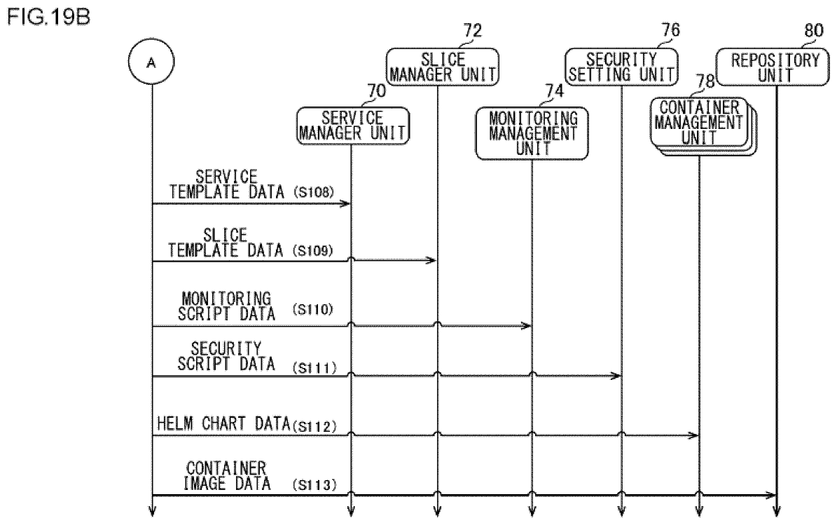

FIGS. 19A and 19B are flowcharts of an onboarding process 1900, in accordance with one or more embodiments.

The flows of processes performed by the vendor terminal 16, the MPS 10, and the NOS 12 when an onboarding button 40 is clicked by a vendor on an onboarding screen such as that shown in FIG. 7 will be explained with reference to flowcharts shown in FIGS. 19A and 19B.

In step S101, the vendor terminal 16 transmits bundle data arranged in a path specified on the onboarding screen to the bundle development unit 60 of the NOS 12.

In step S102, the bundle development unit 60 develops the bundle data received in step S101 and generates a data group such as that shown in FIG. 9.

In step S103, the bundle development unit 60 determines a bundle ID corresponding to the data group generated in step S102.

The bundle development unit 60 then transmits product catalog data included in the data group generated in step S102 that is linked to the bundle ID determined in step S103 to the bundle management unit 50 of the MPS 10.

In step S104, the bundle management unit 50 of the MPS 10 stores the received product catalog data in the product catalog storage unit 52.

The bundle development unit 60 then outputs service catalog data included in the data group generated in step S102 that is linked to the bundle ID determined in step S103 to the E2EO unit 62.

In step S105, the E2EO unit 62 stores the received service catalog data in the service catalog storage unit 64.

In step S106, the bundle development unit 60 causes the inventory management unit 66 to store inventory template data included in the data group generated in step S102 that is linked to the bundle ID determined in step S103.

In step S107, the bundle development unit 60 causes the CMaaS unit 68 to store CM template data included in the data group generated in step S102 that is linked to the bundle ID determined in step S103.

In step S108, the bundle development unit 60 then causes the service manager unit 70 to store service template data included in the data group generated in step S102 that is linked to the bundle ID determined in step S103.

In step S109, the bundle development unit 60 causes the slice manager unit 72 to store slice template data included in the data group generated in step S102 that is linked to the bundle ID determined in step S103.

In step S110, bundle development unit 60 causes the monitoring management unit 74 to store monitoring script data included in the data group generated in step S102 that is linked to the bundle ID determined in step S103.

In step S111, bundle development unit 60 causes the security setting unit 76 to store security script data included in the data group generated in step S102 that is linked to the bundle ID determined in step S103.

In step S112, bundle development unit 60 causes the container management unit 78 to store Helm chart data included in the data group generated in step S102 that is linked to the bundle ID determined in step S103. For example, the bundle development unit 60 may store the Helm chart included in the data group generated in step S102 in a plurality of container management units 78. In some embodiments, Helm chart data associated with the container management unit 78 is stored in the container management unit 78.

In step S113, the bundle development unit 60 causes the repository unit 80 to store container image data included in the data group generated in step S102 that is linked to the bundle ID determined in step S103.

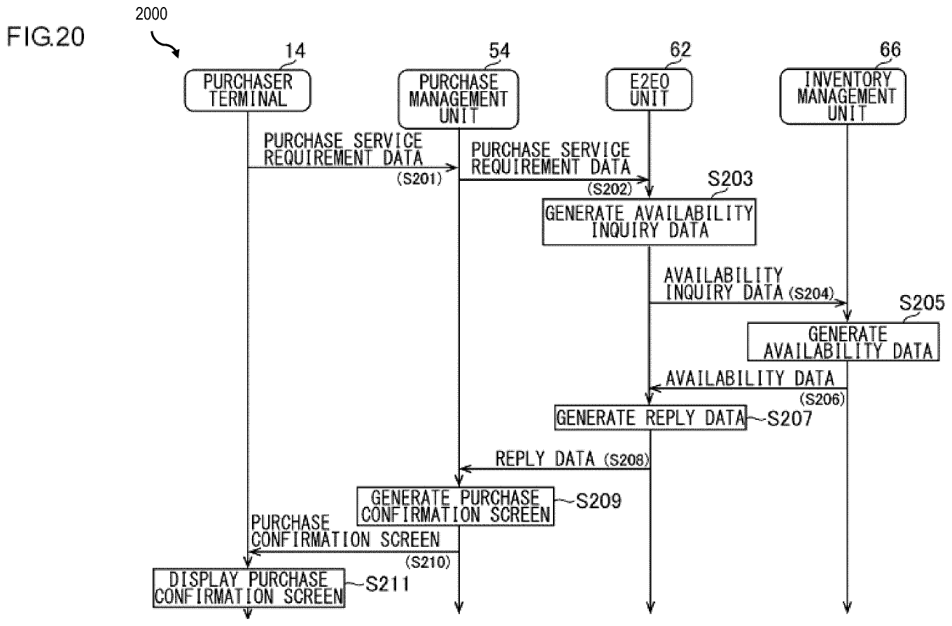

FIG. 20 is a flowchart of processes 2000 executed by the purchaser terminal 14, the MPS 10, and the NOS 12 when the next button 32 is clicked by the purchaser on the service requirement input screen such as that shown in FIG. 3, in accordance with one or more embodiments.

In step S201, the purchaser terminal 14 transmits the purchase service requirement data linked to the purchase bundle ID to the purchase management unit 54 of the MPS 10. The purchase bundle ID is a bundle ID of a network service selected by the purchaser on the purchase screen such as that shown in FIG. 2. The purchase service requirement data is service requirement data such as that indicating the details of input onto the service requirement input screen shown in FIG. 3.

In step S202, the purchase management unit 54 of the MPS 10 transmits the purchase service requirement data linked to the purchase bundle ID received in step S201 to the E2EO unit 62 of NOS 12.

In step S203, the E2EO unit 62 of the NOS 12 generates availability inquiry data based on the service catalog data linked to the purchase bundle ID. For example, availability inquiry data is generated that indicates the types of functional unit groups that realize the network service to be purchased and the number of functional units for each type.

In step S204, E2EO unit 62 outputs the availability inquiry data generated in step S203 to the inventory management unit 66.

In step S205, the inventory management unit 66 generates availability data based on the received availability inquiry data, inventory data, and inventory template data. For example, availability data is generated that indicates whether (1) a hardware resource in which a functional unit group indicated by the received availability inquiry data is deployed can be secured, (2) the hardware resource can be secured by adding a free server to the resource pool, or (3) the hardware resource cannot be secured.

In step S206, the inventory management unit 66 transmits the availability data generated in step S205 to the E2EO unit 62.

In step S207, the E2EO unit 62 then generates reply data based on the availability data received in the process shown in S206. For example, when the availability data indicates (1) or (2) above, reply data indicating OK is generated, and when the availability data indicates (3) above, reply data indicating NG is generated.

In step S208, the E2EO unit 62 transmits the reply data generated in step S207 to the purchase management unit 54 of the MPS 10.

In step S209, the purchase management unit 54 generates a purchase confirmation screen such as that shown in FIG. 4 or FIG. 5 based on the reply data received in step S208. For example, when the received replay data indicates OK, a purchase confirmation screen such as that shown in FIG. 4 indicating that immediate provision is possible is generated. On the other hand, when the received reply data indicates NG, a purchase confirmation screen such as that shown in FIG. 5 indicating that a predetermined turnaround time is required (e.g., turnaround time of 2 weeks is required) is generated.

In step S210, the purchase management unit 54 transmits the purchase confirmation screen generated in step S209 to the purchaser terminal 14.

In step S211, the purchaser terminal 14 displays the purchase confirmation screen received in step S210 on the display of the purchaser terminal 14.

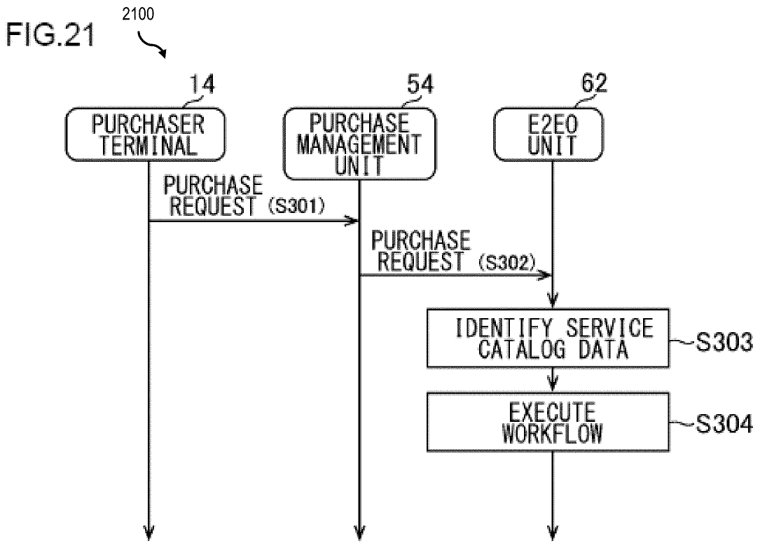

FIG. 21 is a flowchart of processes 2100 executed by the purchaser terminal 14, the MPS 10, and the NOS 12 when a purchase button 34 is clicked by the purchaser such as that shown on the purchase confirmation screen in FIG. 4 or FIG. 5, in accordance with one or more embodiments.

In step S301, the purchaser terminal 14 transmits a purchase request for the network service to the purchase management unit 54 of the MPS 10. It is assumed that the purchase request is linked to the purchase bundle ID and the purchase service requirement data transmitted in step S201 (FIG. 20).

In step S302, the purchase management unit 54 transmits the purchase request linked to the purchase bundle ID and the purchase service requirement data received in step S301 to the E2EO unit 62.

In step S303, the E2EO unit 62 identifies service catalog data corresponding to the purchase bundle ID linked to the received purchase request.

In step S304, the E2EO unit 62 acquires the service catalog data identified in step S303 from the service catalog storage unit 64 and executes the workflow script indicated by the service catalog data.

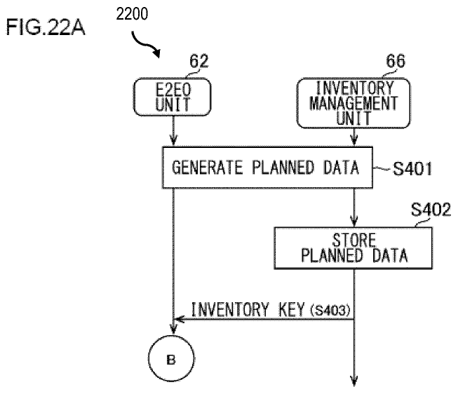

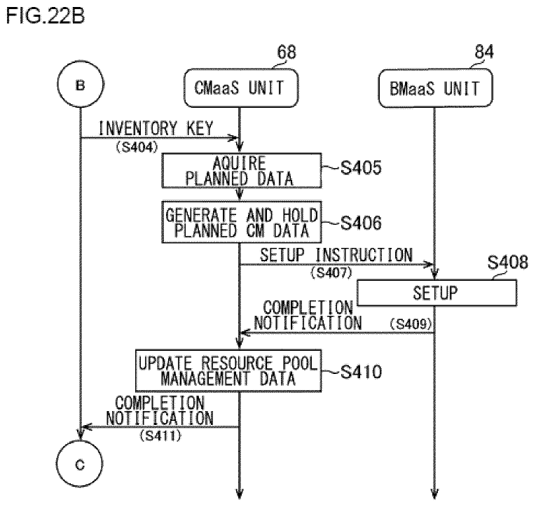

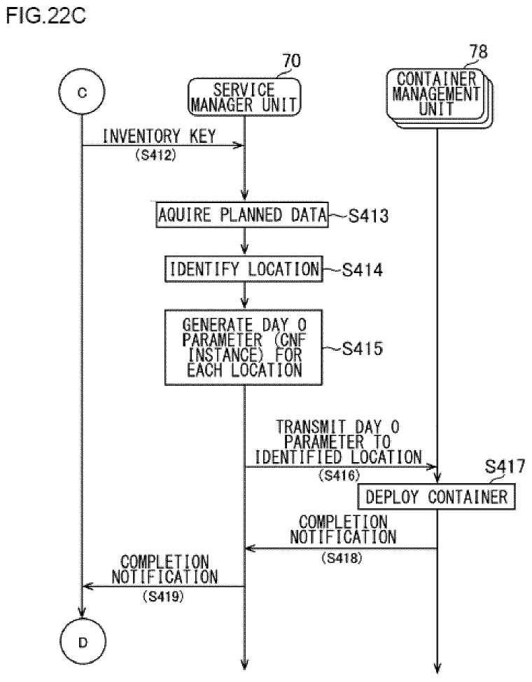

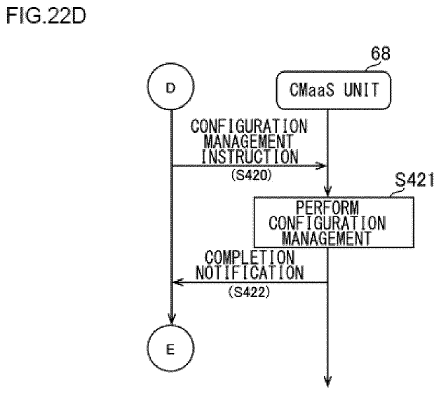

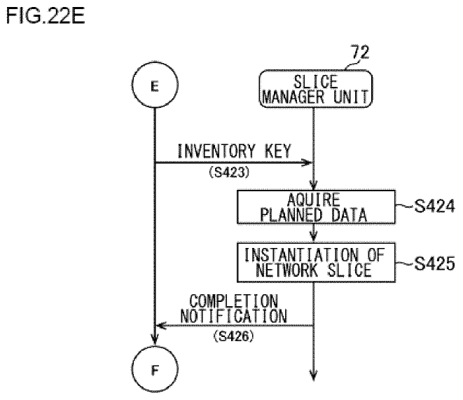

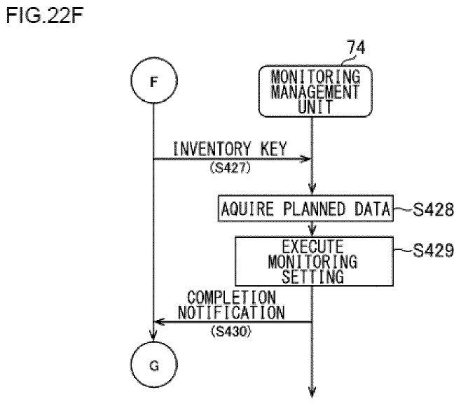

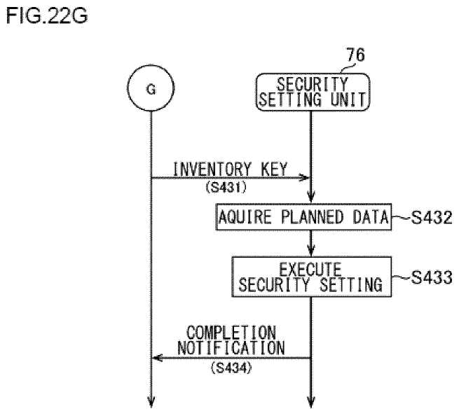

FIGS. 22A to 22G are flowcharts of processes 2200 corresponding to step S304, in accordance with one or more embodiments.

In step S401, the E2EO unit 62 and the inventory management unit 66 generate planned data based on the purchase service requirement data, service catalog data, inventory template data, and inventory data linked to the purchase request. The process executed in step S401 includes, for example, a process of identifying a resource pool, where a functional unit group is deployed, and a necessary resource.

In step S402, the inventory management unit 66 stores the generated planned data in the inventory database 82.

In step S403, the inventory management unit 66 outputs an inventory key included in the generated planned data to the E2EO unit 62.

In step S404, the E2EO unit 62 outputs the inventory key that has been received to the CMaaS unit 68.

In step S405, CMaaS unit 68 acquires planned data including the received inventory key from the inventory database 82.

In step S406, the CMaaS unit 68 generates and holds planned CM data including a day 1 parameter based on the planned data acquired in step S405.

In step S407, the CMaaS unit 68 outputs an instruction for a setup such as securing necessary hardware resources to the BMaaS unit 84.

In step S408, the BMaaS unit 84 performs a setup such as securing hardware resources according to the instruction. At this time, the setup of system software according to a specific type of functional unit and addition of a free server to the resource pool are executed.

In some embodiments, a free server is added to the resource pool with an enough margin (buffer). For example, a plurality of servers 90 may be collectively added to the resource pool.

In step S409, the BMaaS unit 84 outputs a completion notification to the CMaaS unit 68.

In step S410, the CMaaS unit 68 updates the resource pool management data. For example, the value of the remaining core number data of the resource pool for which the hardware resources are secured may be subtracted. Further, the number of free servers and the value of the total core number data may be updated. In some embodiments, the BMaaS unit 84 updates the resource pool management data instead of the CMaaS unit 68. In some embodiments, the inventory management unit 66 updates the resource pool management data based on an instruction from the CMaaS unit 68.

In step S411, the CMaaS unit 68 outputs a completion notification to the E2EO unit 62.

In step S412, the E2EO unit 62 outputs the inventory key received in the process shown in S403 to the service manager unit 70.

In step S413, the service manager unit 70 acquires planned data including the received inventory key from the inventory database 82.

In step S414, the service manager unit 70 identifies a location where the functional unit group is deployed based on the planned data acquired in step S418.

In step S415, the service manager unit 70 generates a day 0 parameter (e.g, CNF instance) for each location identified in step S414.

In step S416, the service manager unit 70 outputs a day 0 parameter corresponding to the container management unit 78 to a container management unit 78 corresponding to each location identified in step S414.

In step S417, the container management unit 78 executes the deployment of a container based on the day 0 parameter that has been received.

In step S418, the container management unit 78 outputs a completion notification to the service manager unit 70.

In step S419, the service manager unit 70 outputs the completion notification to the E2EO unit 62.

In step S420, the E2EO unit 62 outputs a configuration management instruction that is based on the day 1 parameter to the CMaaS unit 68.

In step S421, CMaaS unit 68 performs the configuration management of a container group that is based on the day 1 parameter included in the held planned CM data.

In step S422, the CMaaS unit 68 outputs a completion notification to the E2EO unit 62.

In step S423, the E2EO unit 62 outputs the inventory key received in step S403 to the slice manager unit 72.

In step S424, the slice manager unit 72 acquires planned data including the received inventory key from the inventory database 82.

In step S425, the slice manager unit 72 executes the instantiation of a network slice based on the planned data acquired in step S429. In some embodiments, the slice manager unit 72 outputs a configuration management instruction in step S425 related to the instantiation of the network slice to the CMaaS unit 68. The CMaaS unit 68 then performs configuration management such as configuring settings according to the configuration management instruction.

In some embodiments, the CMaaS unit 68 updates the day 1 parameter based on the configuration management instruction received from the slice manager unit 72 in step S425 without performing steps S420 to S422. The CMaaS unit 68 then performs configuration management such as configuring settings according to the configuration management instruction.

In step S426, the slice manager unit 72 outputs a completion notification to the E2EO unit 62.

In step S427, the E2EO unit 62 outputs the inventory key received in step S403 to the monitoring management unit 74.

In step S428, the monitoring management unit 74 acquires planned data including the received inventory key from the inventory database 82.

In step S429, the monitoring management unit 74 executes a monitoring setting according to a monitoring policy indicated by the purchase service requirement data based on the planned data acquired in step S428.

In step S430, the monitoring management unit 74 outputs a completion notification to the E2EO unit 62.

In step S431, the E2EO unit 62 outputs the inventory key received in step S403 to the security setting unit 76.

In step S432, the security setting unit 76 acquires planned data including the received inventory key from the inventory database 82.

In step S433, the security setting unit 76 executes a security setting based on the plan data acquired in step S432.

In step S434, the security setting unit 76 outputs a completion notification to the E2EO unit 62.

In some embodiments, the network service provided to the purchaser is implemented by a VNF, which is VM-based functional unit that uses a hypervisor-type or host-type virtualization technology, instead of a CNF, which is a container-based functional unit. When a specific type of functional unit is deployed in an unused hardware resource (e.g., a free server in this case), the setup of system software according to the specific type of functional unit may be performed on a host OS serving as the basis of a virtual machine environment.

In some embodiments, the division of roles for each function shown in FIG. 8 is not limited to that shown in FIG. 8. For example, one or more of the processes performed by the E2EO unit 62 may be performed by the inventory management unit 66. In some embodiments, one or more of the processes performed by the inventory management unit 66 may be performed by the E2EO unit 62.

In some embodiments, the NOS 12 is free from including the repository unit 80. In some embodiments, the bundle development unit 60 stores the Helm chart data and the container image data in the container management unit 78. In some embodiments, the container management unit 78 deploys the container image stored in the container management unit 78.

In some embodiments, the NOS 12 is free from including the bundle development unit 60. For example, a bundle file may be on-boarded from an external file transfer server.

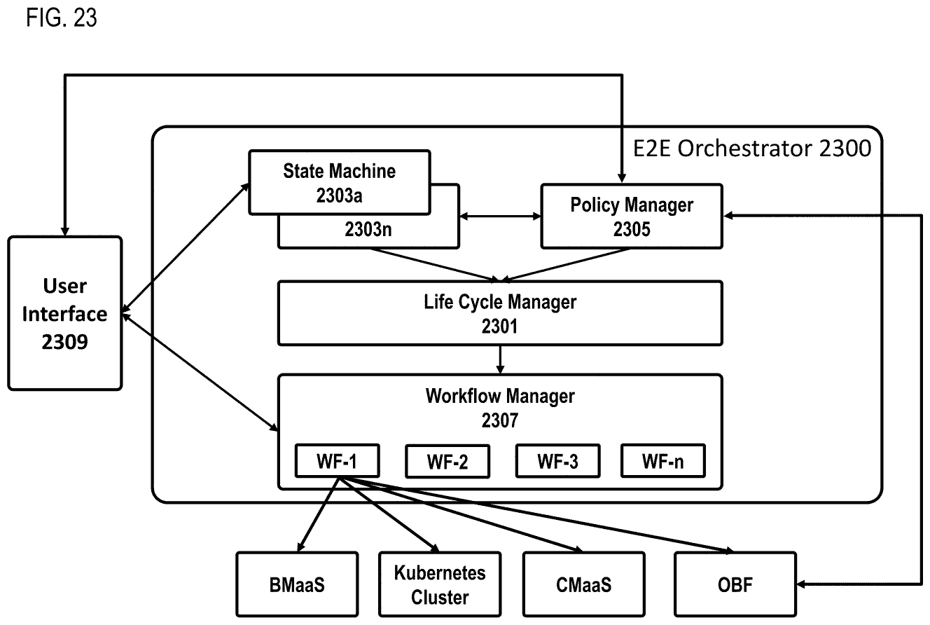

FIG. 23 is a block diagram of an E2EO unit 2300, in accordance with one or more embodiments. In some embodiments, E2EO unit 2300 is usable as E2EO unit 62, discussed above. In some embodiments, E2EO unit 2300 is usable as one or more E2EO unit 62, service manager unit 70, slice manager unit 72, or container management unit 78. E2EO unit 2300 comprises a life cycle manager 2301, one or more state machines 2303a-2303n (collectively referred to as “state machine 2303”), a policy manager 2305, and a workflow manager 2307.

E2EO unit 2300 is configured to facilitate deployment of a new network application or network service without requiring development of new network elements or development of replacement network elements. In some embodiments, E2EO unit 2300 is configured to facilitate end-to-end life cycle of network elements or resources comprising applications, services, clusters, slices, artifacts, or other suitable network function or network resource capable of having a manageable life cycle and being subject to or being the basis for a life cycle management operation for the deployment a new network application or network service without requiring development of new network elements or development of replacement network elements.

The state machines 2303 are dynamically configurable finite state machines with no development required for any number of elements added to E2EO unit 2300. The state machines 2303 can be associated with any network element. Network elements comprise, for example, network resources such as hardware resources associated with, or capable of being used by, a network, or software resources associated with, or capable of being used by, a network, one or more network functions, one or more network services, one or more slice subnets, one or more network slices, one or more network function-service-slice packages, one or more network function-service-slice packages and related artifacts, a slice manager (e.g., slice manager unit 72 in FIG. 1 or some other suitable slice manager), one or more servers (e.g., server 90 in FIG. 1 or some other suitable computer), one or more platform units, CMaaS manager (e.g., CMaaS unit 68 in FIG. 1 or some other suitable CMaaS unit), a BMaaS manager (e.g., BMaaS unit 84 in FIG. 1 or some other suitable BMaaS unit), an inventory manager (e.g., inventory management unit 66 in FIG. 1, or some other suitable inventory manager), a monitoring manager, an observability framework (OBF) unit (e.g., OBF 74 in FIG. 1, or some other suitable OBF unit), a service catalog storage/manager (e.g., service catalog storage unit 64 in FIG. 1, or some other suitable service catalog storage/manager), a Kubernetes service cluster, other suitable cluster, a policy life cycle manager, the policy manager 2305, a hardware switch, a field programmable gate array, a vRAN, a GC, an NFP, or other suitable network element and/or network resource.

Conventional network systems have very fixed interfaces for adding any new network element and require long development and testing cycles. E2EO unit 2300, however, makes it possible to adapt a communication network system such as communication system 100 to facilitate life cycle management of one or more network elements by making changes to existing network elements or adding new network elements by way of easily customizable state machines 2303 and/or pluggable state machines 2303, and/or easily customizable workflows and/or pluggable workflows included in or added to workflow manager 2307.

In some embodiments, E2EO unit 2300 is configured to perform some or all of the functions discussed with respect to one or more of E2EO unit 62, service manager unit 70, slice manager unit 72, or container management unit 78, in addition to making it possible for a vendor to provide custom stated machines 2303, customizable state machines 2303, pluggable state machines 2303, custom workflows, customizable workflows and/or pluggable workflows to be added to workflow manager 2307 or modify one or more states, state machines and/or workflows included in workflow manager 2307 to offer new network services or applications for purchase or deployment.

In some embodiments, one or more of the components included in E2EO unit 2300 include or replace one or more of the components such as computer readable instructions and/or one or more processors included in E2EO unit 62 such that E2EO unit 2300 is configured to perform some or all of the functions discussed with respect to E2EO unit 62 in addition to making it possible for a vendor to provide custom stated machines 2303, customizable state machines 2303, pluggable state machines 2303, custom workflows, customizable workflows and/or pluggable workflows to be added to workflow manager 2307 or modify one or more states, state machines and/or workflows included in workflow manager 2307 to offer new network services or applications for purchase or deployment.

For example, E2EO unit 2300 makes it possible for dynamically created states and/or workflows that can be managed by the life cycle manager 2301 using dynamically created finite state machines used by a vendor to make an intent based system to maintain or change an element status to on-board and deploy a network service or application. In some embodiments, the life cycle manager 2301 is a common life cycle manager for all types of elements and resources to which a state machine 2303 corresponds.

As discussed above, the vendor is provided with a continuous integration (CI)/continuous delivery (CD) pipeline including a development environment, a verification environment, and a test environment. In some embodiments, the continuous integration (CI)/continuous delivery (CD) pipeline includes a user interface 2309 that facilitates customization and/or creation of a state machine 2303 or workflow. In some embodiments, user interface 2309 is a graphical user interface 2309 that facilitates customization or creation of a state machine 2303 or workflow by way of dragging and dropping one or more objects displayed in the graphical user interface. In some embodiments, user interface 2309 is accessible by way of vendor terminal 16.

As discussed above, the service catalog data is, for example, data corresponding to a part of technology section data included in a bundle file. The service catalog data contains one or more workflow scripts for building the network service. In some embodiments, the workflow manager 2307 is communicatively coupled with the service catalog storage unit 64 to cause a workflow to be stored or to access a stored workflow for execution. In some embodiments, the workflow manager 2307 comprises the service catalog storage unit 64, or some other suitable storage. In some embodiments, workflow manager 2307 comprises a workflow engine that executes an instructed workflow.

For example, the service catalog data may include requirement configuration correspondence data indicating the correspondence between the value of the above service requirement data and the configuration of a functional unit group (e.g., a CNF group) constructed in response to a purchase request. The E2EO unit 2300 and the inventory management unit 66 identify the configuration of a functional unit group that realizes a network service to be purchased. In some embodiments, a network service to be purchased comprises, as discussed above, a network slice, a slice subnet, an application, a communication or data service, or some other suitable capability accessible by way of a network associated with E2EO unit 2300. The E2EO unit 2300 and the inventory management unit 66 identify the configuration of a functional unit group that realizes a network service to be purchased based on the service requirement data received from the purchase management unit 54. The E2EO unit 2300 acquires, from the service catalog storage unit 64, service catalog data corresponding to a purchase bundle ID linked to the purchase service requirement data received from the purchase management unit 54. The E2EO unit 2300 causes the workflow manager 2307 to execute one or more workflow scripts indicated by the service catalog data. In some embodiments, the one or more workflow scripts are identified by a finite state machine included as a part of the service catalog data.

As another example, the E2EO unit 2300 and the inventory management unit 66 generate planned data based on the purchase service requirement data received from the purchase management unit 54, the service catalog data linked to the purchase bundle ID, the inventory template data linked to the purchase bundle ID, and the inventory data. The planned data is, for example, data indicating the configuration of a functional unit group that realizes a network service to be purchased. The E2EO unit 2300 causes the workflow manager 2307 to execute one or more corresponding workflow scripts as a trigger.

As discussed above, in some embodiments, network elements such as the CMaaS unit 68, the service manager unit 70, and the slice manager unit 72, or container management unit 78, identify a construction procedure of a functional unit group. For example, the CMaaS unit 68, the service manager unit 70, the slice manager unit 72, and the container management unit 78 construct a functional unit group by executing the identified construction procedure. The CMaaS unit 68 performs configuration management such as the setting of the functional unit based on the day 1 parameter included in the generated planned CM data. The slice manager unit 72 performs, for example, instantiation of a network slice pertaining to a network service to be purchased, based on the above-mentioned planned data and slice template data linked to the purchase bundle ID stored in the slice manager unit 72. The monitoring management unit 74 executes a monitoring setting according to the identified monitoring policy. The E2EO unit 2300 causes the workflow manager 2307 to execute one or more corresponding workflow scripts as a trigger to cause processes executed by the various network elements to perform prescribed functions to deploy a purchased network service or application.

In some embodiments, the user interface 2309 facilitates selecting and/or creating workflows. In some embodiments, the user interface 2309 is a graphical user interface that provides options that can be dragged and dropped for creating workflows using existing functions known to the workflow manager 2305 or using new workflows created, or modified workflows edited, by user by way of a development environment or in a user interface associated with life cycle manager 2301 in which a user may optionally enter custom computer readable code, functions or scripts and/or modify existing computer readable code, functions or scripts.

In some embodiments, E2EO unit 2300 facilitates the dynamic creation or modification of network elements based on schema desired by a user using one or more dynamically created finite state machines and/or workflows. The dynamic creation of one or more of the state machines or workflows for any existing network element, and/or a new network element, be it logical or physical, makes it possible for a modified network element or a new network element to be implemented from day-0 to day-N by E2EO unit 2300 without any changes to the code base or any development effort from an E2EO development team.

In some embodiments, to facilitate the deployment of a new network service or application, the E2EO unit 2300 causes life cycle manager 2301 to cause a network element having one or more states defined in a state machine 2303 corresponding to the network element to transition one or more source states of the one or more states defined in the state machine 2303 to one or more destination states of the one or more states defined in the state machine 2303 based on an instruction to modify the network element. In some embodiments, the instruction is based on a request to add and/or modify a network service or application received from a vendor. In some embodiments, the instruction is based on a purchase of a network service or application previously modified or added to the service catalog by a vendor, for example. In some embodiments, the E2EO unit 2300 further causes the life cycle manager 2301 to determine one or more current states of the network element to be modified based on the instruction to modify the network element. At least one of the one or more source states is one of the one or more current states.

The E2EO unit 2300 causes the life cycle manager 2301 to query workflow manager 2307 to select one or more workflows to modify the network element based on the instruction to modify the network element and the transition of the one or more source states to the one or more destination states. The E2EO unit 2300 then causes the network element to be modified based on the selected one or more workflows selected by the life cycle manager 2301, or planned by life cycle manager 2301 to be modified. In some embodiments, the transition of the one or more source states to the one or more destination states is caused to occur by executing one or more selected workflows. For example, in some embodiments, the modification of the network element is caused by a combination of two or more transitions from two or more source states to two or more destination states and two or more selected workflows. In some embodiments, one or more selected workflows serve as triggers to cause a destination state to occur.

In some embodiments, if a selected workflow fails to make a destination state occur, the workflow manager 2307 informs the life cycle manager 2301 of the failure and the life cycle manager 2301 causes the state of the network element to transition to a failed state or revert to the source state. In some embodiments, based on the states defined in the applicable state machine 2303 and one or more policies defined in the policy manager 2305 corresponding to one or more of the state machine 2303, a selected workflow, a network element, a run-time of a state in the state machine 2303 or the selected workflow, the life cycle manager 2301 causes the workflow to be retried to cause the destination state to occur, or causes a combination of other transitions and workflows to occur such that the destination state is achieved by way of an alternative path.

In some embodiments, the E2EO unit 2300 makes it possible to create new states or new state machines 2303 by way of graphical user interface 2309. For example, based on a request to create a new state or a new state machine 2303, E2EO unit 2300 causes the graphical user interface 2309 to be output by a display associated a computer such as vendor terminal 16. The E2EO unit 2300 then causes at least one of a new state to be created and included in a selected state machine 2303 based on a user input, a new state to be added to the selected state machine 2303 from a list of available states based on the user input, at least one of the one or more states defined in the selected state machine 2303 to be modified, or a new state machine 2303 to be created based on the user input. In some embodiments, the modification of the one or more states defined in the state machine 2303 causes a change to a run-time of at least one of the one or more states defined in the state machine. In some embodiments, when creating a new state or a new state machine 2303, user interface 2309 makes it possible to set a run-time for one or more states in the new state machine 2303 or a newly created state. In some embodiments, user interface 2309 makes it possible for a new state or a new state machine 2303 to be created while a communication system implementing E2EO unit 2300 is running and operational without causing the communication system, a portion thereof, or E2EO unit 2300 to be shut down while creating, developing or implementing the new state or a new state machine 2303. In some embodiments, the set run-time is a time during which a network element configuration based on one or more states or a newly created state machine, for example, is implemented by executing one or more workflow scripts involving the states and/or newly created state machine while a communication system implementing E2EO unit 2300 is running and operational without causing the communication system, a portion thereof, or E2EO unit 2300 to be shut down while creating, developing or implementing the new state or a new state machine 2303. In some embodiments, the user input is identified based on a detected drag and drop operation of an object in the graphical user interface 2309.

In some embodiments, the E2EO unit 2300 causes the graphical user interface 2309 to be output by a display and causes at least one of a new workflow to be created and included in the workflow manager 2307 based on the user input, a new workflow to be added to the workflow manager 2307 from a list of available workflows based on the user input, or at least one of the one or more workflows included in the workflow manager 2300 to be modified based on the user input. In some embodiments, the user input is identified based on a detected drag and drop operation of an object in the graphical user interface 2309.

In some embodiments, the one or more workflows corresponds to a type of network element and comprises one or more of an operating system installation, an upgrade, a firmware upgrade, a change in BIOS settings, or some other suitable operation or event.

In some embodiments, the one or more states comprise a failed state, an active state, a ready state, a registered state, an installed state, a discovered state, a validated state, an instantiated state, a null state, a terminated state, or some other suitable state.

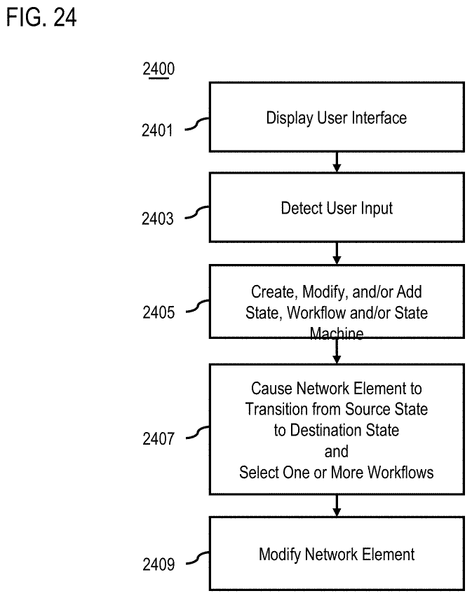

FIG. 24 is a flowchart of a method 2400 for generating one or more workflows or one or more states, in accordance with one or more embodiments. In some embodiments, method 2400 is at least partially performed by a processor such as processor 12a or processor 3603.

In step 2401, a graphical user interface is caused to be output by a display. The user interface comprises one or more options to create or modify a state of a network element available to be included in a state machine or existing in a state machine, to create or modify one or more workflows, and/or create or modify a state machine.

In step 2403, a user input received by way of the graphical user interface is detected.

In step 2405, at least one of a new state is caused to be created and included in a state machine based on the user input, a new state is caused to be added to the state machine from a list of available states based on the user input, or at least one of the one or more states defined in the state machine is caused to be modified based on the user input, and/or at least one of a new workflow is caused to be created and included in a workflow manager based on the user input, a new workflow is caused to be added to the workflow manager from a list of available workflows based on the user input, or at least one of the one or more workflows included in the workflow manager is caused to be modified based on the user input.

In step 2407, a life cycle manager is caused to cause a network element having one or more states defined in the state machine corresponding to the network element to transition one or more source states of the one or more states defined in the state machine to one or more destination states of the one or more states defined in the state machine based on an instruction to modify the network element. In some embodiments, the life cycle manager is caused to determine one or more current states of the network element based on the instruction to modify the network element, and at least one of the one or more source states is one of the one or more current states.

The life cycle manager is caused to query the workflow manager to select one or more workflows to modify the network element based on the instruction to modify the network element and the transition of the one or more source states to the one or more destination states.

In step 2409, the network element is caused to be modified based on the selected one or more workflows.

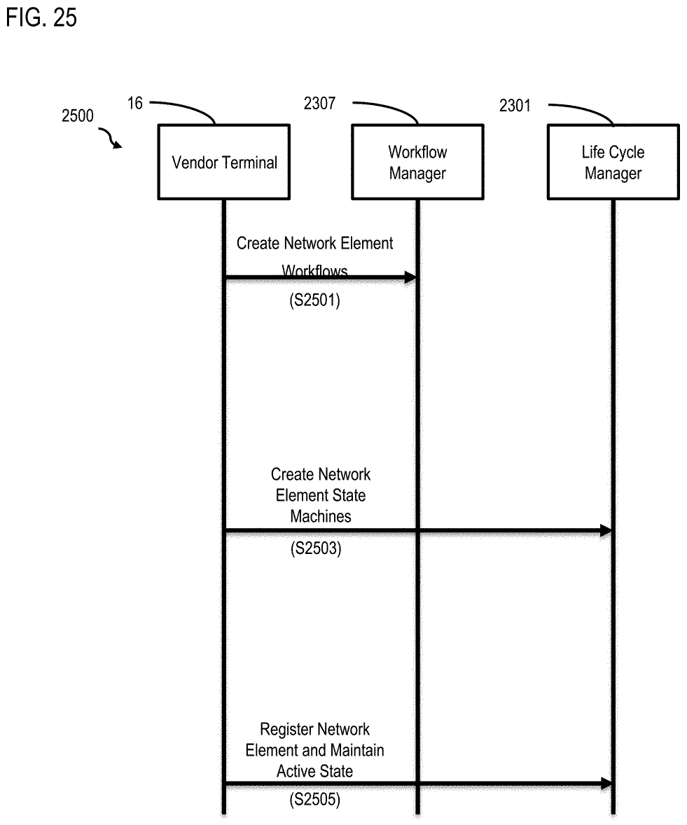

FIG. 25 is a flowchart of a process 2500 for registering a network element, in accordance with one or more embodiments.

In step 2501, one or more network element workflows are created by way of vendor terminal 16 and provided to the workflow manager 2307. For example, a user of vendor terminal 16 creates one or more workflows using graphical user interface 2309 to cause specified steps that one or more network elements are instructed to follow during an application instantiation process.

In step 2503, one or more state machines are created by way of vendor terminal 16 and provided to life cycle manager 2301. The one or more state machines are to be managed by the life cycle manager 2301. For example, based on the one or more workflows created, the user of vendor terminal 16 defines one or more states indicating when to call which workflow. In some embodiments, the defined states of when to call a workflow facilitates automating a request. In some embodiments, the defined states of when to call a workflow facilitates automatic healing of a network connectivity issue and/or network element malfunction.

In some embodiments, the life cycle manager 2301 is configured to receive a finite state machine as a plug-in. In some embodiments, the life cycle manager 2301 is configured to manage two or more finite state machines. In some embodiments, the life cycle manager 2301 is configured to receive and manage two or more finite state machines. In some embodiments, the life cycle manager 2301 is configured to manage a plurality of state machines created or modified and/or manage a plurality of plug-in finite state machines.

In step 2505, an instruction is communicated from the vendor terminal 16 to the life cycle manager 2301 that causes the life cycle manager 2301 to register the network element and maintain an active state. In some embodiments, the instruction is based on a user input received by way of the vendor terminal 16. In some embodiments, the instruction is an actuation of a workflow that involves keeping the network element in the active state. In some embodiments, the active state is maintained based on one or more of a run-time, a policy, or an instruction to transition to a different state, for example.

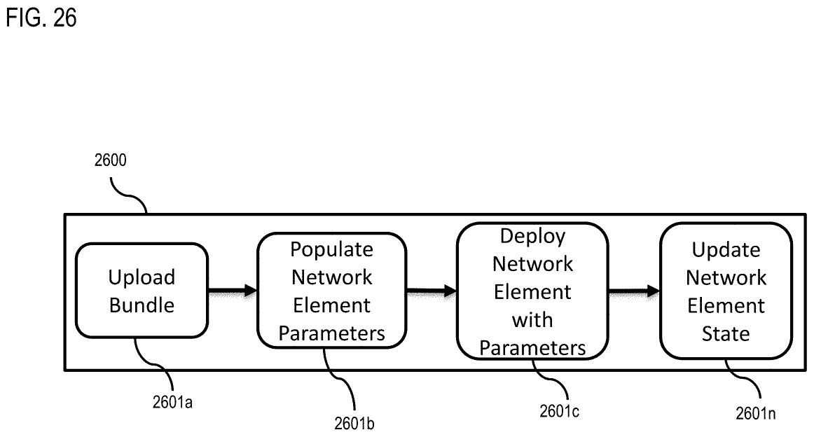

FIG. 26 is a diagram of a workflow 2600, in accordance with one or more embodiments. Workflow 2600 is a deploy network element workflow. Workflow 2600 is viewable by way of user interface 2309. Workflow 2600 comprises a series of processes or events 2601a-2601n (collectively referred to as “process or event 2601”) that are caused to occur to cause a change in state from a source state to a destination state of a network element. Workflow 2600 comprises processes or events 2601 including upload bundle 2601a, populate network element parameters 2601b, deploy network element with parameters 2601c, and update network element state 2601n.

In some embodiments, one or more of processes or events 2601 is capable of being edited by way of a development environment, for example. In some embodiments, workflow 2600 is capable of being modified by removing one or more of processes or events 2601a-2601n, or editing or creating one or more other processes or events 2601 to the workflow based on a selection of available process or event options from a list of available options and/or a drag and drop operation of a graphical user interface object into the workflow 2600 by way of user interface 2309.

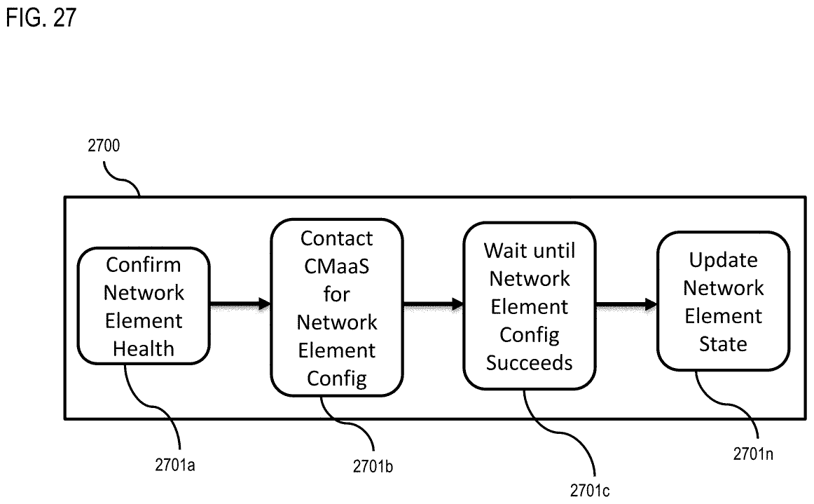

FIG. 27 is a diagram of a workflow 2700, in accordance with one or more embodiments. Workflow 2700 is a configure network element workflow. Workflow 2700 is viewable by way of user interface 2309. Workflow 2700 comprises a series of processes or events 2701a-2701n (collectively referred to as “process or event 2701”) that are caused to occur to cause a change in state from a source state to a destination state of a network element. Workflow 2700 comprises processes or events 2701 including confirm network element health 2701a, contact CMaas for network element configuration 2701b, wait until network element configuration succeeds 2701c, and update network element state 2701n.

In some embodiments, one or more of processes or events 2701 is capable of being edited by way of a development environment, for example. In some embodiments, workflow 2700 is capable of being modified by removing one or more of processes or events 2701a-2701n, or adding one or more other processes or events 2701 to the workflow based on a selection of available process or event options from a list of available options and/or a drag and drop operation of a graphical user interface object into the workflow 2700 by way of user interface 2309.

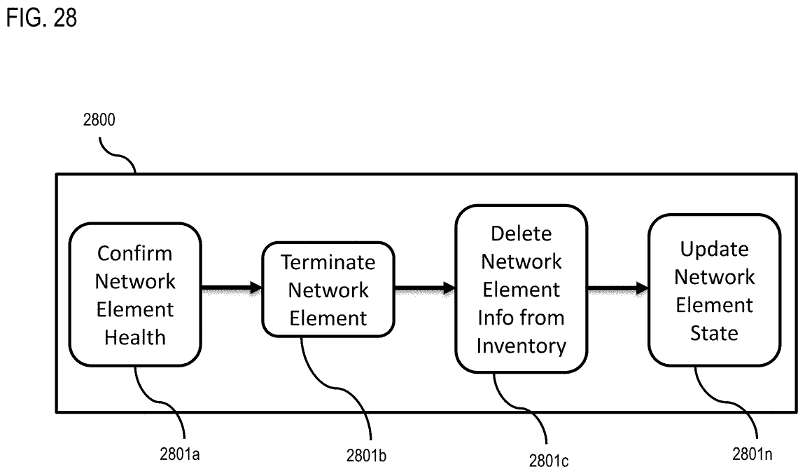

FIG. 28 is a diagram of a workflow 2800, in accordance with one or more embodiments. Workflow 2800 is a terminate network element workflow. Workflow 2800 is viewable by way of user interface 2309. Workflow 2800 comprises a series of processes or events 2801a-2801n (collectively referred to as “process or event 2801”) that are caused to occur to cause a change in state from a source state to a destination state of a network element. Workflow 2800 comprises processes or events 2801 including confirm network element health 2801a, delete network element 2801b, delete network element information from inventory 2801c, and update network element state 2801n.

In some embodiments, one or more of processes or events 2801 is capable of being edited by way of a development environment, for example. In some embodiments, workflow 2800 is capable of being modified by removing one or more of processes or events 2801a-2801n, or adding one or more other processes or events 2801 to the workflow based on a selection of available process or event options from a list of available options and/or a drag and drop operation of a graphical user interface object into the workflow 2800 by way of user interface 2309.

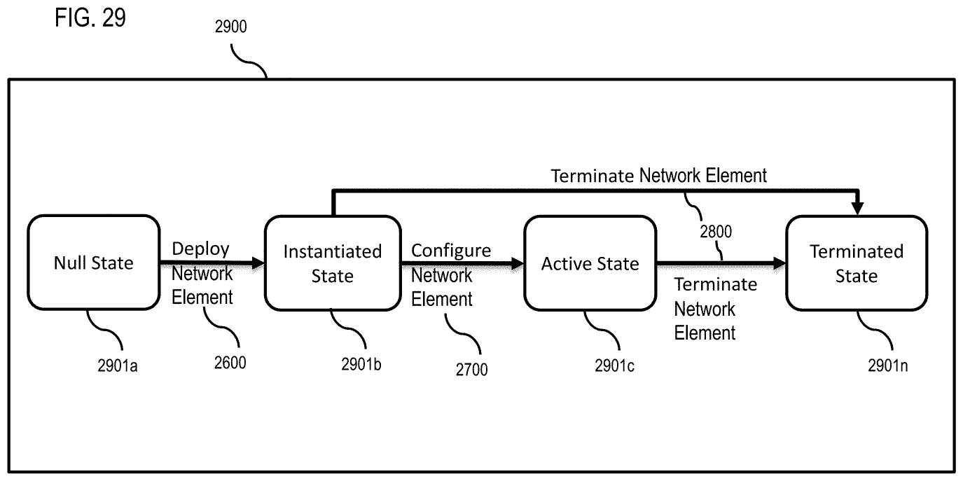

FIG. 29 is a diagram of a state machine 2900, in accordance with one or more embodiments. State machine 2900 is a finite state machine. State machine 2900 is viewable by way of user interface 2309. State machine 2900 comprises a plurality of states 2901a-2901n (collectively referred to as “states 2901”) of a network element. State machine 2900 comprises states 2901 including a null state 2901a, an instantiated state 2901b, an active state 2901c, and a terminated state 2901n. Workflows 2600, 2700 and 2800 cause the state of the network element to transition from a source state to a destination state based on a completion of the requisite workflow. For example, deploy network element workflow 2600 causes the network element to transition from null state 2901a to instantiated state 2901b, configure network element workflow causes the network element to transition from instantiated state 2901b to active state 2901c, and workflow 2800 causes the network element to transition from active state 2901c to terminated state 2901n or workflow 2800 causes the network element to transition from instantiated state 2901b to terminated state 2901n.

In some embodiments, one or more of states 2901 is capable of being edited by way of a development environment, for example. In some embodiments, state machine 2900 is capable of being modified by removing one or more of states 2901a-2901n, or adding one or more other states 2901 and/or other workflow to the state machine based on a selection of available state or workflow options from a list of available options and/or a drag and drop operation of a graphical user interface object into the state machine 2900 by way of user interface 2309. For example, state machine 2900 is capable of being modified by an authorized user or a vendor having authority using user interface 2309 to cause a network element of a network element-type to always remain in the active state. E2EO unit 2300 causes the life cycle manager 2301 to select appropriate workflows to make sure that the network element remains in the active state by automatically planning and causing the workflow manager 2307 to run the selected workflows to maintain the active state.

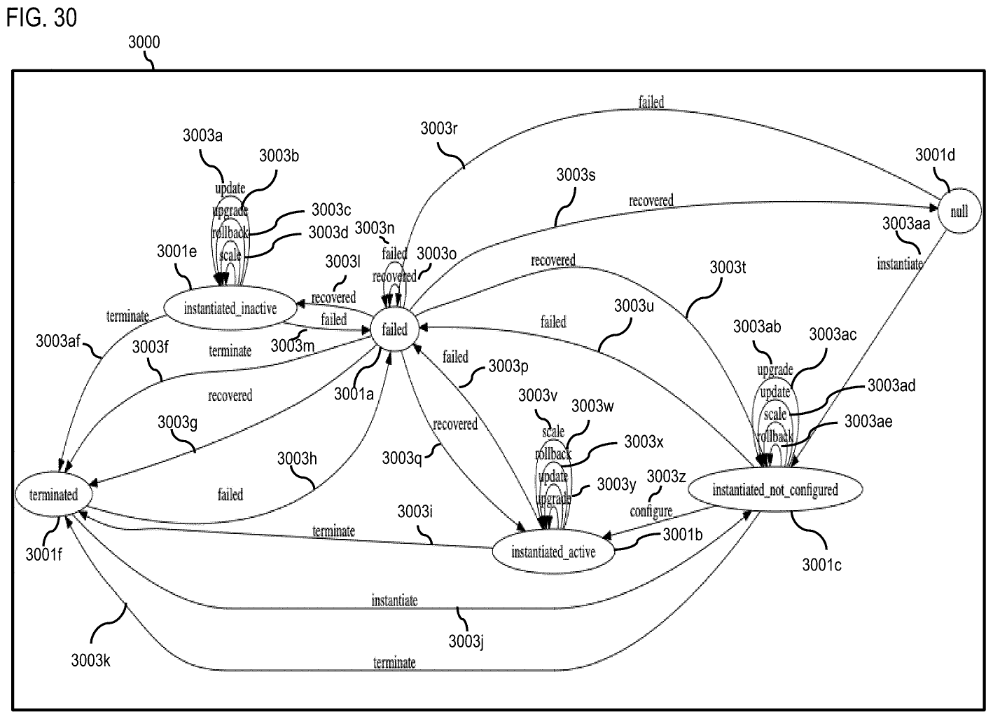

FIG. 30 is a diagram of a state machine 3000, in accordance with one or more embodiments. State machine 3000 is a finite state machine. State machine 3000 is viewable by way of user interface 2309. State machine 3000 comprises a plurality of states 3001a-3001n (collectively referred to as “states 3001”) of a network element. State machine 3000 comprises states 3001 including a failed state 3001a, an instantiated_active state 3001b, an instantiated_not_configured state 3001c, a null state 3001d, an instantiated_inactive state 3001e, and a terminated stated 3001f. In some embodiments, one or more other states such as a ready state, an installed state, a validated state, a registered state, or some other suitable state is optionally included in state machine 3000 in addition to, or as an alternative to, the example states 3100a-3100f. Workflows 3003a-3003af (collectively referred to as “workflows 3003”) cause the state of the network element to transition from a source state to a destination state based on a completion of the requisite workflow.

In some embodiments, one or more of states 3001 is capable of being edited by way of a development environment, for example. In some embodiments, state machine 3000 is capable of being modified by removing one or more of states 3001a-3001e, or adding one or more other states 3001 and/or other workflows 3003 to the state machine 3000 based on a selection of available state or workflow options from a list of available options and/or a drag and drop operation of a graphical user interface object into the state machine 3000 by way of user interface 2309.

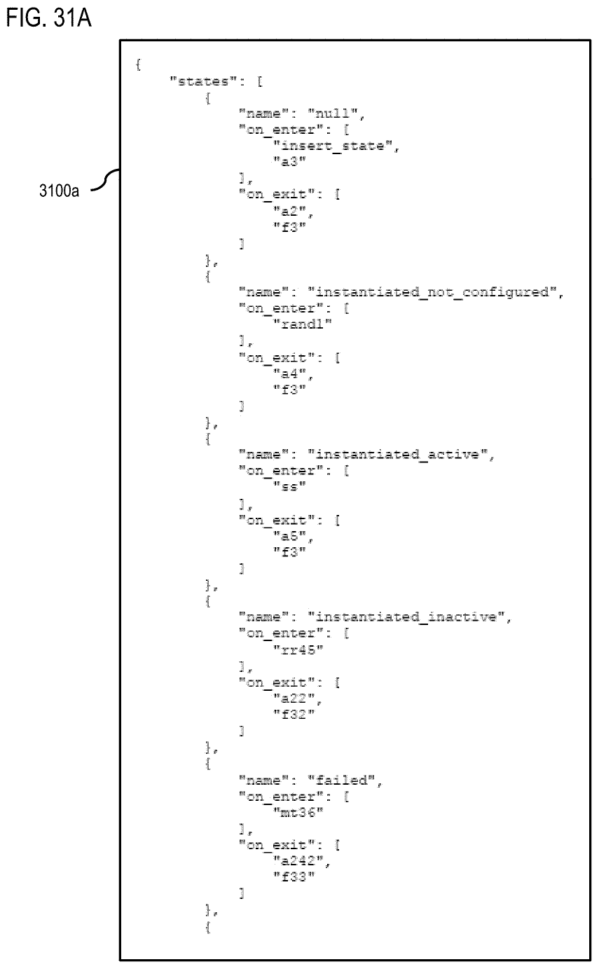

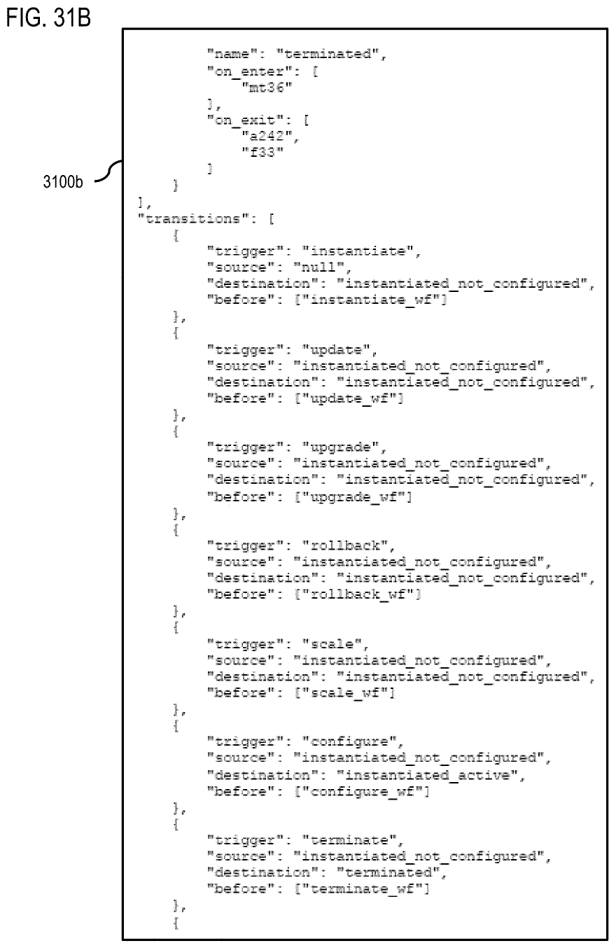

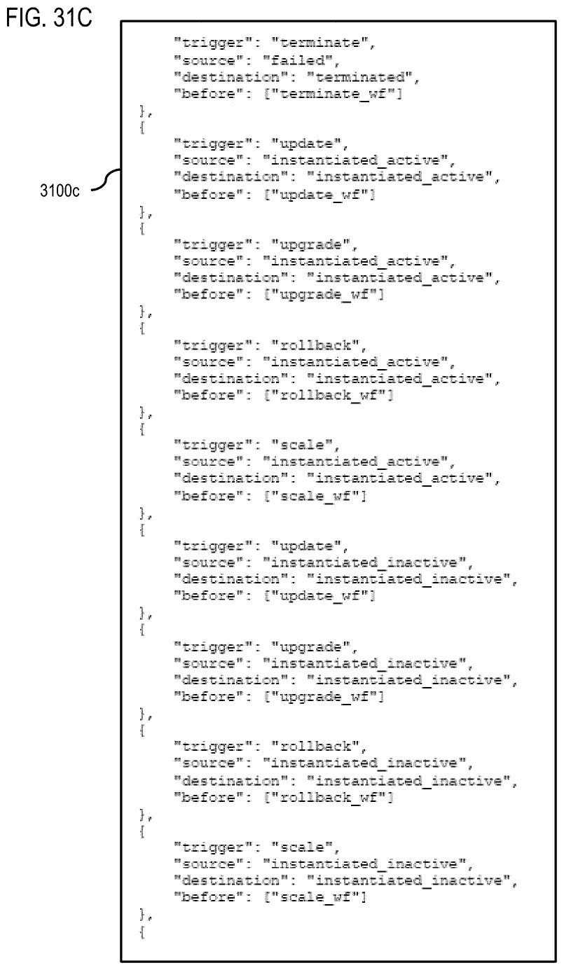

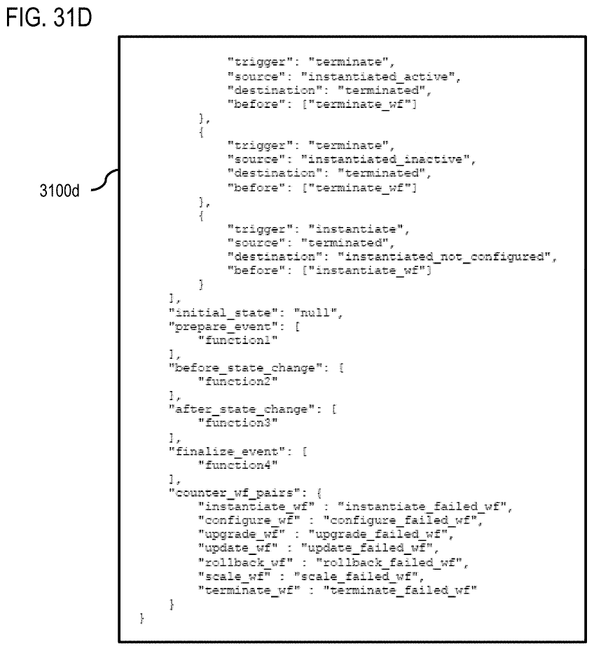

FIGS. 31A-31D are diagrams of a state machine creation and code viewing interface 3100a-3100d (collectively referred to as “state machine creation and code viewing interface 3100”), in accordance with one or more embodiments. In some embodiments, state machine creation and code viewing interface 3100 is viewable by way of user interface 2309. State machine creation and code viewing interface 3100, as shown in FIGS. 31A-31D, comprises computer readable code that corresponds to the states 3001 and workflows 3003 included in state machine 3000. In some embodiments, the state machine 3000 is created based on the code in state machine creation and code viewing interface 3100. In some embodiments, the code in state machine creation and code viewing interface 3100 is created based on the state machine 3000 being created and/or modified in user interface 2309. In some embodiments, the state machine 3000 is modified based on one or more changes made to the computer readable code in the state machine creation and code viewing interface 3100. In some embodiments, state machine creation and code viewing interface 3100 is an integrated development environment, or other suitable code editor. In some embodiments, state machine creation and code viewing interface 3100 is viewable by accessing a user interface associated with life cycle manager 301 in E2EO 2300.

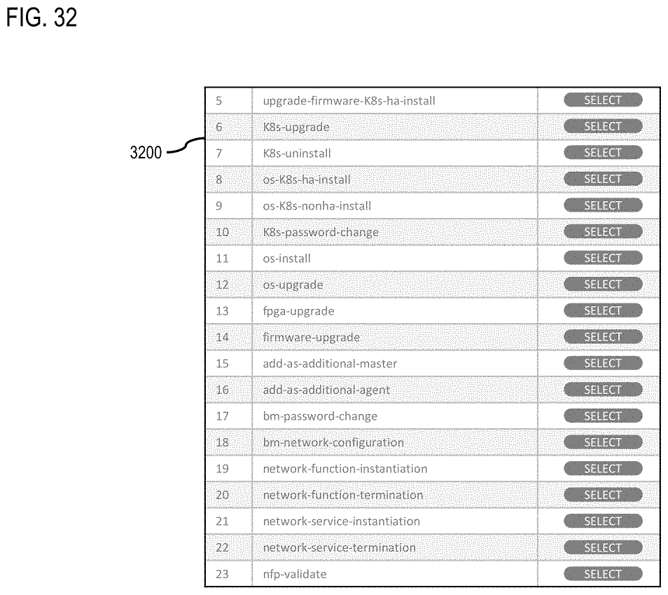

FIG. 32 is a diagram of a workflow selection interface 3200, in accordance with one or more embodiments. In some embodiments, workflow selection interface 3200 is viewable by way of user interface 2309. Workflow selection interface 3200 comprises one or more workflows available to be selected by life cycle manager 2301 based on a transition from a source state to a destination state of a network element. In some embodiments, workflow selection interface 3200 makes it possible to define a workflow correspondence to one or more network elements and/or states. In some embodiments, workflow selection interface 3200 makes it possible to combine one or more processes or events available in workflow selection interface 3200 to create a workflow. In some embodiments, workflow selection interface 3200 makes it possible to create one or more new workflows. In some embodiments, workflow selection interface makes it possible to modify one or more existing workflows. In some embodiments, workflow selection interface 3200 is configured to display workflows available in workflow manager 2307, added to workflow manager 2307. In some embodiments, workflow selection interface 3200 makes it possible to delete one or more workflows from workflow manager 2307. In some embodiments, the selection or creation of one or more workflows for inclusion in the workflow manager 2307 makes it possible for a user to create a new state or a new state machine.

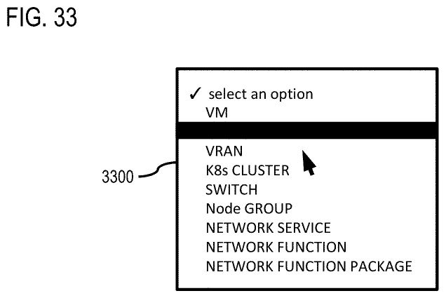

FIG. 33 is a diagram of a network element-type selection interface 3300, in accordance with one or more embodiments. In some embodiments, network element-type selection interface 3300 is viewable by way of user interface 2309. Network element-type selection interface 3300 is a drop-down box including a list of network elements that are capable of being modified, controlled or added to provide a network service. In some embodiments, network element-type interface 3300 is some other suitable format indicative of network elements that are capable of being modified, controlled or added to provide a network service.

Based on a selection of a network element in the network element-type interface 3300, a corresponding list of available processes or events is caused to be displayed to facilitate creation or modification of a workflow, state, or state machine that corresponds to the network element-type.

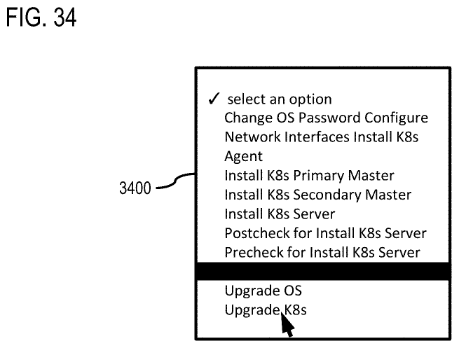

FIG. 34 is a diagram of a process or event interface 3400, in accordance with one or more embodiments. In some embodiments, process or event interface 3400 is viewable by way of user interface 2309. Process or event interface 3400 is a drop-down box including a list of processes or events that are capable of being modified or added to be used as a workflow or added to a workflow to provide a network service. In some embodiments, process or event interface 3400 is some other suitable format indicative of processes or events that are capable of being modified or added to be used as a workflow or added to a workflow to provide a network service.

Based on a selection of a process or event in process or event interface 3400, the selected process or event is added to one or more of a workflow or a state machine, for example. In some embodiments, based on a selection of a process or event in process or event interface 3400, the selected process or event is made ready to be modified. For example, based on a selection of a process or event in process or event interface 3400, computer readable code associated with the selected process or event is caused to be displayed by way of state machine creation and code viewing interface 3100, wherein the computer readable code is optionally edited to facilitate a change to the selected process or event.

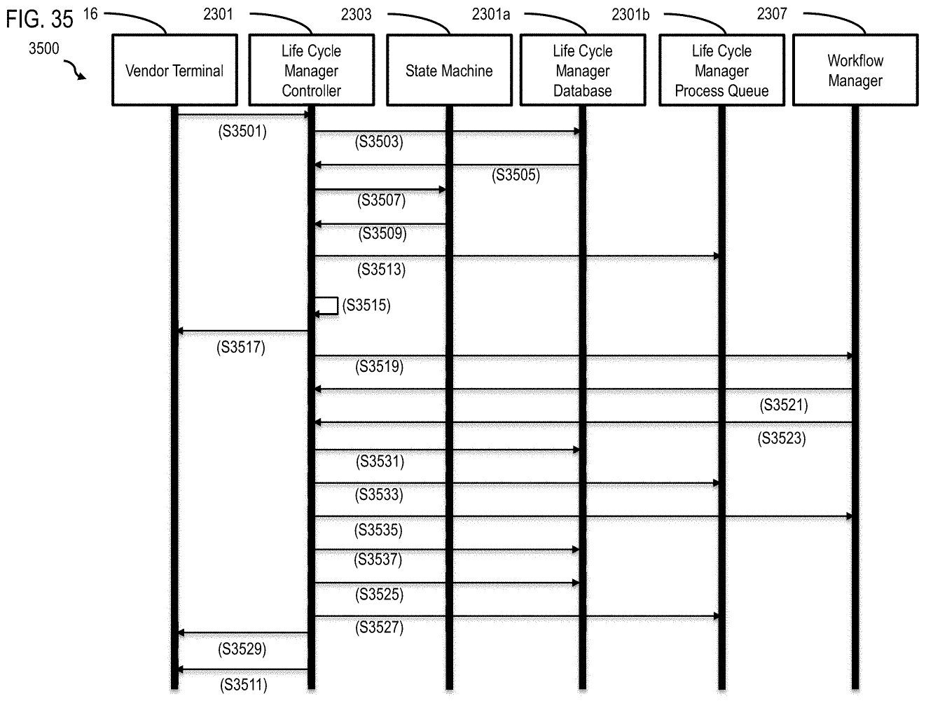

FIG. 35 is a flow chart of a processes 3500 performed by E2EO unit 2300, in accordance with one or more embodiments.

In step S3501, life cycle manager 2301 receives an instruction to change the state of a network element from a source state to a destination state. The instruction is received based on an interaction with vendor terminal 16 using user interface 2309, for example. In some embodiments, the instruction is a request message having information comprising an intended state as the destination state and workflow related data.

In step S3503, the life cycle manager 2301 queries a life cycle database 2301a having the current state of one or more network elements stored therein to get the current state of the network element corresponding to a network element ID included in the instruction. In some embodiments, the life cycle manager database 2301a is included in life cycle manager 2301. In some embodiments, the life cycle manager database 2301a is stored in a memory included or having connectivity to E2EO unit 2300.

In step S3505, the life cycle database 2301a returns the current state of the requested network element to the life cycle manager 2301.

In step S3507, life cycle manager 2301 queries state machine 2303 to determine whether the intended state indicated in the instruction is reachable.

In step S3509, state machine 2303 confirms or rejects the reachability of the intended state. Based on a determination that the intended state is reachable in step S3509, state machine 2303 sends a message to life cycle manager 2301 indicating that the intended destination state is reachable and at least one path to the intended destination state exists. In some embodiments, based on a determination that the intended state is reachable in step S3509, state machine 2303 sends a message to life cycle manager 2301 comprises one or more possible paths that are possible for reaching the intended state.

Life cycle manager 2301 is configured to select a path to transition the current state of the network element to the intended destination state. In some embodiments, the possible paths are weighted. In some embodiments, one or more of the possible paths have at least one intermediary state between the current state and the intended destination state to which the network element must transition en route to the intended destination state. In some embodiments, a weighting of the possible paths is based on process time, a complexity, a quantity of changes of states, an amount of memory or other resources consumed to achieve the intended state, or some other suitable factor.

Based on a determination that the intended state is not reachable in step S3509, state machine 2303 sends a message to life cycle manager 2301 indicating that the intended destination state is not reachable and a path to the intended destination state does not exist.

If the intended destination state is not reachable, life cycle manager 2301 proceeds to step S3511 and sends a response message to the vendor terminal 16 indicating that a path to the intended destination state does not exist.

If the intended destination state is reachable, life cycle manager 2301 proceeds to step S3513 in which life cycle manager 2301 chooses a path of the one or more possible paths and one or more workflows associated with the chosen path adds the chosen path(s) and related workflows to a life cycle manager process queue 2301b. In some embodiments, each element ID included in the instruction has one entry corresponding to the chosen path and the workflow ID(s) corresponding to the chosen path.

In step S3515, life cycle manager 2301 generates a job tracker ID.

In step S3517, life cycle manager 2301 sends a response message to the vendor terminal 16 comprising the job tracker ID.

In step S3519, life cycle manager 2301 executes the selected path(s) and causes life cycle manager 2307 to execute the selected workflows related to the selected path to cause network element to transition to the intended destination state by sending one or more messages to the workflow manager 2307.

In step S3521, workflow manager 2307 sends a message to life cycle manager 2301 comprising the job ID.

In step S3523, workflow manager 2307 sends a message to life cycle manager 2301 comprising a workflow completion status. The workflow completion status comprises an indication of whether the workflow succeeded or failed.

If the workflow completion status comprises an indication that the workflow succeeded, the state of the network element is changed to the intended destination state, or an intermediary state included in the selected path caused by a successful workflow, and life cycle manager 2301 proceeds to step S3525.

In step S3525, life cycle manager 2301 causes the state of the network element to be updated to the intended destination state, or an intermediary state, in the life cycle management database 2301a.

In step S3527, life cycle manager 2301 fetches a next workflow included in the selected path from the life cycle manager process queue 2301b and proceeds to step S3519 to cause workflow manager 2307 to execute the next workflow. The process loops until the network element is caused to transition to the intended destination state.

In step S3529, life cycle manager 2301 sends a notification message to the vendor terminal 16 indicating that the network element transitioned to the intended destination state.

If the workflow completion status comprises an indication that the workflow failed, life cycle manager 2301 proceeds to step S3531. In step S3531, life cycle manager 2301 causes the state of the network element to be updated to a failed state in the life cycle management database 2301a.

In step S3533, life cycle manager 2301 fetches a recovery workflow from the life cycle manager process queue 2301b and proceeds to step S3535 to cause workflow manager 2307 to execute the recovery workflow. In some embodiments, the recovery workflow is the workflow that failed. In some embodiments, the recovery workflow is a workflow included in an alternative path that is optionally executed based on a failure of a selected workflow. In some embodiments, the recovery workflow is executed to automatically attempt to cause the network element to transition to the intended destination state or intermediary state despite a workflow failure. In some embodiments, the life cycle manager 2301 continues to attempt to achieve the transition to the intended destination state or intermediary state until the workflow or recovery workflow is successful, or a predetermined quantity of attempts to achieve the intended destination state or intermediary state is determined to fail, or a predetermined period of time passes, indicating that the failed state remains.

In step S3537, life cycle manager 2301 causes the state of the network element to be updated in the life cycle management database 2301a to the intended destination state, an intermediary state, remain in the failed state, or return to a previous state based on a determined success or failure of the recover workflow.

If the recovery workflow fails and the life cycle manager 2301 updates the life cycle management database 2301a to indicate the network element remains in the failed state or a previous state, the life cycle manager 2301 proceeds to step S3511 and sends a response message to the vendor terminal 16 indicating that a path to the intended destination state does not exist.

If the recovery workflow is successful, life cycle manager 2301 proceeds to step S3529 and sends a notification message to the vendor terminal 16 indicating that the network element transitioned to the intended destination state.

FIG. 36 is a functional block diagram of a computer or processor-based system 3600 upon which or by which an embodiment is implemented.

Processor-based system 3600 is programmed to cause one or more new network elements to be added to a communication system and/or one or more existing network elements to be modified to facilitate constructing and deploying a network service or application, as described herein, and includes, for example, bus 3601, processor 3603, and memory 3605 components.

In some embodiments, the processor-based system is implemented as a single “system on a chip.” Processor-based system 3600, or a portion thereof, constitutes a mechanism for performing one or more steps of causing one or more new network elements to be added to a communication system and/or one or more existing network elements to be modified to facilitate constructing and deploying a network service or application.

In some embodiments, the processor-based system 3600 includes a communication mechanism such as bus 3601 for transferring information and/or instructions among the components of the processor-based system 3600. Processor 3603 is connected to the bus 3601 to obtain instructions for execution and process information stored in, for example, the memory 3605. In some embodiments, the processor 3603 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 3603. Similarly, an ASIC is configurable to perform specialized functions not easily performed by a more general purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 3603 performs a set of operations on information as specified by a set of instructions stored in memory 3605 related to causing one or more new network elements to be added to a communication system and/or one or more existing network elements to be modified to facilitate constructing and deploying a network service or application. The execution of the instructions causes the processor to perform specified functions.

The processor 3603 and accompanying components are connected to the memory 3605 via the bus 3601. The memory 3605 includes one or more of dynamic memory (e.g., RAM, magnetic disk, writable optical disk, etc.) and static memory (e.g., ROM, CD-ROM, etc.) for storing executable instructions that when executed perform the steps described herein to cause one or more new network elements to be added to a communication system and/or one or more existing network elements to be modified to facilitate constructing and deploying a network service or application. The memory 3605 also stores the data associated with or generated by the execution of the steps.

In one or more embodiments, the memory 3605, such as a random access memory (RAM) or any other dynamic storage device, stores information including processor instructions for causing one or more new network elements to be added to a communication system and/or one or more existing network elements to be modified to facilitate constructing and deploying a network service or application. Dynamic memory allows information stored therein to be changed. RAM allows a unit of information stored at a location called a memory address to be stored and retrieved independently of information at neighboring addresses. The memory 3605 is also used by the processor 3603 to store temporary values during execution of processor instructions. In various embodiments, the memory 3605 is a read only memory (ROM) or any other static storage device coupled to the bus 3601 for storing static information, including instructions, that is not capable of being changed by processor 3603. Some memory is composed of volatile storage that loses the information stored thereon when power is lost. In some embodiments, the memory 3605 is a non-volatile (persistent) storage device, such as a magnetic disk, optical disk or flash card, for storing information, including instructions, that persists even when the system 3600 is turned off or otherwise loses power.

The term “computer-readable medium” as used herein refers to any medium that participates in providing information to processor 3603, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description relates to an apparatus comprising a processor and a memory having computer readable instructions stored thereon that, when executed by the processor, cause the apparatus to cause a life cycle manager to cause a network element having one or more states defined in a state machine corresponding to the network element to transition one or more source states of the one or more states defined in the state machine to one or more destination states of the one or more states defined in the state machine based on an instruction to modify the network element. The apparatus is also caused to cause the life cycle manager to query a workflow manager to select one or more workflows to modify the network element based on the instruction to modify the network element and the transition of the one or more source states to the one or more destination states. The apparatus is further caused to cause the network element to be modified based on the selected one or more workflows.

Another aspect of this description relates to a method that comprises causing a life cycle manager, executed by a processor, to cause a network element having one or more states defined in a state machine corresponding to the network element to transition one or more source states of the one or more states defined in the state machine to one or more destination states of the one or more states defined in the state machine based on an instruction to modify the network element. The method also comprises causing the life cycle manager to query a workflow manager to select one or more workflows to modify the network element based on the instruction to modify the network element and the transition of the one or more source states to the one or more destination states. The method further comprises causing the network element to be modified based on the selected one or more workflows.

Another aspect of this description relates to a non-transitory computer readable medium having instructions stored thereon that, when executed by a processor, cause an apparatus to cause a life cycle manager to cause a network element having one or more states defined in a state machine corresponding to the network element to transition one or more source states of the one or more states defined in the state machine to one or more destination states of the one or more states defined in the state machine based on an instruction to modify the network element. The apparatus is also caused to cause the life cycle manager to query a workflow manager to select one or more workflows to modify the network element based on the instruction to modify the network element and the transition of the one or more source states to the one or more destination states. The apparatus is further caused to cause the network element to be modified based on the selected one or more workflows.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An apparatus comprising:
a processor; and
a memory having computer readable instructions stored thereon that, when executed by the processor, cause the apparatus to:
cause a life cycle manager to cause a network element having one or more states defined in a state machine corresponding to the network element to transition one or more source states of the one or more states defined in the state machine to one or more destination states of the one or more states defined in the state machine based on an instruction to modify the network element;
cause the life cycle manager to query a workflow manager to select one or more workflows to modify the network element based on the instruction to modify the network element and the transition of the one or more source states to the one or more destination states; and
cause the network element to be modified based on the selected one or more workflows.

2. The apparatus of claim 1, wherein the apparatus is further caused to:
cause the life cycle manager to determine one or more current states of the network element based on the instruction to modify the network element, at least one of the one or more source states is one of the one or more current states.

3. The apparatus of claim 1, wherein the apparatus is further caused to:
cause a graphical user interface to be output by a display;
detect a user input received by way of the graphical user interface; and
cause at least one of a new state to be created and included in the state machine based on the user input, a new state to be added to the state machine from a list of available states based on the user input, or a modification of one or more of the one or more states defined in the state machine based on the user input.

4. The apparatus of claim 3, wherein the modification of the one or more states defined in the state machine causes a change to a run-time of at least one of the one or more states defined in the state machine.

5. The apparatus of claim 3, wherein the user input is identified based on a detected drag and drop operation of an object in the graphical user interface.

6. The apparatus of claim 1, wherein the apparatus is further caused to:
cause a graphical user interface to be output by a display; and
cause at least one of a new workflow to be created and included in the workflow manager based on the user input, a new workflow to be added to the workflow manager from a list of available workflows based on the user input, or a modification of one or more of the one or more workflows included in the workflow manager based on the user input.

7. The apparatus of claim 6, wherein the user input is identified based on a detected drag and drop operation of an object in the graphical user interface.

8. The apparatus of claim 1, wherein the network element is a type of network element comprising one or more of a network function, a network service, a bare metal as a service (BMaaS) manager, a slice manager, a configuration management as a service (CMaaS) manager, a kubernetes service cluster, a policy manager, a hardware switch, or a virtual Radio Access Network (vRAN).

9. The apparatus of claim 8, wherein the one or more workflows corresponds to the type of network element and comprises one or more of an operating system installation, an upgrade, a firmware upgrade, or a change in BIOS settings.

10. The apparatus of claim 1, wherein the one or more states comprise a failed state, a ready state, a registered state, an installed state, or a validated state.

11. The apparatus of claim 1, wherein the modification of the network element is caused by a combination of two or more transitions from two or more source states to two or more destination states and two or more selected workflows.

12. A method, comprising:
causing a life cycle manager, executed by a processor, to cause a network element having one or more states defined in a state machine corresponding to the network element to transition one or more source states of the one or more states defined in the state machine to one or more destination states of the one or more states defined in the state machine based on an instruction to modify the network element;
causing the life cycle manager to query a workflow manager to select one or more workflows to modify the network element based on the instruction to modify the network element and the transition of the one or more source states to the one or more destination states; and
causing the network element to be modified based on the selected one or more workflows.

13. The method of claim 12, further comprising:
causing the life cycle manager to determine one or more current states of the network element based on the instruction to modify the network element, at least one of the one or more source states is one of the one or more current states.

14. The method of claim 12, further comprising:
causing a graphical user interface to be output by a display;
detecting a user input received by way of the graphical user interface; and
causing at least one of a new state to be created and included in the state machine based on the user input, a new state to be added to the state machine from a list of available states based on the user input, or a modification of one or more of the one or more states defined in the state machine based on the user input.

15. The method of claim 14, wherein the modification of the one or more states defined in the state machine causes a change to a run-time of at least one of the one or more states defined in the state machine.

16. The method of claim 12, further comprising:
causing a graphical user interface to be output by a display; and
causing at least one of a new workflow to be created and included in the workflow manager based on the user input, a new workflow to be added to the workflow manager from a list of available workflows based on the user input, or a modification of one or more of the one or more workflows included in the workflow manager based on the user input.

17. The method of claim 12, wherein the network element is a type of network element comprising one or more of a network function, a network service, a bare metal as a service (BMaaS) manager, a slice manager, a configuration management as a service (CMaaS) manager, a kubernetes service cluster, a policy manager, a hardware switch, or a virtual Radio Access Network (vRAN).

18. The method of claim 17, wherein the one or more workflows corresponds to the type of network element and comprises one or more of an operating system installation, an upgrade, a firmware upgrade, or a change in BIOS settings.

19. The method of claim 12, wherein the one or more states comprise a failed state, a ready state, a registered state, an installed state, a discovered state, or a validated state.

20. A non-transitory computer readable medium having instructions stored thereon that, when executed by a processor, cause and apparatus to:
cause a life cycle manager to cause a network element having one or more states defined in a state machine corresponding to the network element to transition one or more source states of the one or more states defined in the state machine to one or more destination states of the one or more states defined in the state machine based on an instruction to modify the network element;
cause the life cycle manager to query a workflow manager to select one or more workflows to modify the network element based on the instruction to modify the network element and the transition of the one or more source states to the one or more destination states; and
cause the network element to be modified based on the selected one or more workflows.
